(19) United States
(12) Patent Application Publication
(10) Pub. No.: US 2019/0074567 A1
(43) Pub. Date: Mar. 7, 2019

(54) RADIO FREQUENCY (RF) COUPLER

(71) Applicant: Raytheon Company, Waltham, MA (US)

(72) Inventors: Christopher M. Laighton, Boxborough, MA (US); Susan C. Trulli, Lexington, MA (US); Elicia K. Harper, Chelsea, MA (US)

(73) Assignee: Raytheon Company, Waltham, MA (US)

(21) Appl. No.: 15/693,743

(22) Filed: Sep. 1, 2017

(51) Int. Cl. H01P 5/18

(52) U.S. Cl. CPC H01P 5/184

(57) ABSTRACT

An RF coupler having: a pair of input ports; a pair of output ports; and a coupling region for coupling: a portion of an input signal at a first one of the input ports to first of the pair of output ports and another portion of the input signal fed to the first one of the input ports a second one of the output ports; and one portion of an input signal fed to a second one of the input ports to the second of the pair of output ports and another portion of the input signals fed to the second one of the input ports to the second one of the output ports. The coupling region comprises a plurality of serially connected, vertically stacked, coupling sections. Each one of a plurality of electrically conductive layers is disposed between a pair of the vertically stacked coupling sections.

### TECHNICAL FIELD

This disclosure relates generally to radio frequency (RF) couplers and more particularly to compact RF couplers.

### BACKGROUND

As is known in the art, Radio Frequency (RF) couplers are four port or input/output RF devices and have a wide range of applications. One type of coupler is a quadrature coupler shown in FIGS. 1A and 1B to include: a pair of strip conductors SC1, SC2 physically separated one from the other by a dielectric board B1 and disposed between a pair of ground plane conductors GP1, GP2 formed on the upper surfaces of a corresponding one of a pair of dielectric boards B2 and B3, respectively, as shown. More particularly, each one of the a pair of strip conductors SC1, SC2 has an input port I1, I2, respectively, coupled to a pair of output ports O1, O2, respectively, through an electromagnetic coupling region CR. The electromagnetic coupling region CR is a region where a portion of the strip conductors SR1 SR2, in this configuration, vertically overlay one another and are separated by a vertical gap G. It is in this electromagnetic coupling region CR that radio frequency energy passing through the strip conductors SC1, SC2 is coupled between the pair of strip conductors SC1, SC2 by electromagnetically passing through the gap G. It is noted that the opposing ends of strip conductor SC1 are connected to the input port I1 and the output port O1, respectively, while the opposing ends of the strip conductor SC 2 are connected to the input port I2 and the output port O2, respectively as shown. More particularly, one portion of an input signal fed input port I1 passes to output port O1 and another portion of the input signal at input port I1 is coupled by the electromagnetic coupling region CR to both output ports O1 and O2; output port O2 typically being connected to a matched load, not shown. The above described coupler is sometimes referred to as an overlay coupler; another type of coupler is a broadside coupler (FIGS. 1C and 1D where instead of the electromagnetic coupling region CR being a pair of overlaying strip conductors, as in FIGS. 1A and 1B, the pair of strip conductors SC1, SC2 are on the same surface of a common dielectric board Ba and the portions of the strip conductors SC1, SC2 in the electromagnetic coupling region CR are in a side by side arrangement and are separated by a horizontal gap G. Thus, while here again the pair of strip conductors SC1, SC2 are physically separated one from the other by a dielectric boards Ba and B1, radio frequency energy is electromagnetically coupled between the strip conductors SC1, SC2 by electromagnet energy passing between them through the gap G. Thus, here again, it is in this electromagnetic coupling region CR that radio frequency energy passing through the strip conductors SC1, SC2 is electromagnetically coupled between the pair of strip conductors SC1, SC2.

It is desirable that the surface area occupied by the coupler be minimized. Several couplers are discussed in the following papers: Design of Compact Multilevel Folded-Line RF Couplers by Stettaluri et al., IEEE TRANSACTIONS ON MICROWAVE THEORY AND TECHNIQUES, VOL. 47, NO. 12, DECEMBER 1999, pages 2331-2339; and COMPACT MULTI-LEVEL FOLDED COUPLED LINE RF COUPLERS, Settaluri et al., 1999 IEEE MTT-S Digest pages 1721-1724.

### SUMMARY

In accordance with the present disclosure, an RF coupler is provided, comprising: a pair of dielectrically separated strip conductors; and a coupling section. The coupling section includes: a plurality of serially connected, vertically stacked, coupling sections, each one of the coupling sections comprising adjacent portions of the pair of strip conductors separated by a dielectric gap, the gap forming an electromagnetic coupling region between the adjacent portions of the pair of strip conductors. The coupler includes a plurality of electrically conductive layers, each one of the electrically conductive layers being disposed between a corresponding pair of the vertically stacked coupling sections.

In one embodiment, the adjacent portions of the pair of strip conductors in each one of the coupling sections are disposed in an overlaying relationship in a vertical plane.

In one embodiment, the adjacent portions of the pair of strip conductors in each one of the coupling sections are disposed in a side-by-side relationship in a horizontal plane.

In one embodiment, an RF coupler is provided, comprising: a pair of dielectrically separated strip conductors; and a coupling section. The coupling section includes: a plurality of serially connected, vertically stacked, coupling sections, each one of the coupling sections comprising adjacent portions of the pair of strip conductors, disposed in an overlaying relationship in a vertical plane, and separated by a dielectric gap, the gap forming an electromagnetic coupling region between the adjacent portions of the pair of strip conductors.

In one embodiment, each one of the coupling sections includes a pair of strip conductors separated by a dielectric, a first one of the pair of strip conductors having one end coupled to the first one of the input ports and an opposite end coupled to the second output port, and a second one of the pair of strip conductors having one end coupled to the second input port and an opposite end coupled to the first output port.

In one embodiment, said one end of one of the second one of the pair of strip conductors is connected to said opposite end of the first one of the pair of strip conductors.

In one embodiment, the coupler includes a plurality of horizontally disposed dielectric layers, each one of the dielectric layers being disposed on a corresponding one of the strip conductors of the serially connected, vertically stacked, coupling sections.

In one embodiment, the coupler includes a plurality of electrically conductive layers, each one of the electrically conductive layers being disposed between a corresponding pair of the coupling sections.

In one embodiment, the coupler includes an additional electrically conductive layer disposed over an upper most one of the serially connected, vertically stacked, coupling sections.

In one embodiment, the plurality of connected electrically conductive layers is disposed between a corresponding pair of the dielectric layers, the electrically conductive layers being disposed over an upper most one of the serially connected, vertically stacked, coupling sections, and the sides of the electrically conductive layers being disposed on side of the vertically stacked, coupling sections.

The details of one or more embodiments of the disclosure are set forth in the accompanying drawings and the description below. Other features, objects, and advantages of the disclosure will be apparent from the description and drawings, and from the claims.

### DESCRIPTION OF DRAWINGS

FIGS. 1A and 1B are a diagrammatical plan and cross sectional sketches of a coupler according to the PRIOR ART, the cross sectional sketch of FIG. 1B being taken along line 1B-1B of FIG. 1A;

FIGS. 1C and 1D are a diagrammatical plan and cross sectional sketches of a coupler according to the PRIOR ART, the cross sectional sketch of FIG. 1D being taken along line 1D-1D of FIG. 1C;

FIG. 2A is a plan view sketch of a coupler according to the disclosure;

FIG. 2B is cross sectional view sketch of the coupler of FIG. 2A, such cross section being taken along line 2B-2B of FIG. 2A;

FIG. 2C is cross sectional view sketch of the coupler of FIG. 2A, such cross section being taken along line 2C-2C of FIG. 2A;

FIG. 2D is a perspective view sketch of a portion of the of the coupler of FIG. 2A;

FIGS. 3A-3T are plan, cross sectional and perspective views of the coupler of FIG. 2A at various stages in the fabrication thereof wherein FIGS. 3A-3T are plan views; 3A′-3T′ are cross sectional views taken along lines 3A′-3T′ in FIGS. 3A-3T, respectively; FIGS. 3B″-3T″ are cross sectional views taken along lines 3B″-3T″ in FIGS. 3B-3T, respectively; and FIGS. 3B′″-3D′″, 3G′″-3K′″, 3N′″, 3P′″-3T′″ are perspective views of a portions of the coupler;

FIG. 4 is a perspective sketch of portions of the coupler of FIG. 2A with dielectric layers thereof being removed and a portion of one of the electrically conductive layers thereof partially broken away for simplicity in understanding the orientation of other shown portions of the coupler; and

FIGS. 5A-5D are plane, cross-sectional and perspective view sketches of an RF coupler according to another embodiment of the disclosure; FIG. 5A being a plan view, FIG. 5B being a cross sectional view, such cross section being taken along line 5B-5B in FIG. 5A, FIG. 5C being a cross sectional view, such cross section being taken along line 5C-5C in FIG. 5A, FIGS. 5B′ and 5C′ being more cross sectional views of FIG. 5B being a cross sectional view, such cross section being taken along line 5B-5B in FIG. 5A and FIG. 5C′ being a cross sectional view, such cross section being taken along line 5C-5C in FIG. 5A such FIGS. 5B′ and 5C′ being useful in understanding the fabrication of the RF coupler of FIGS. 5A, 5B and 5C; and FIG. 5D being a perspective view sketch showing the arrangement of strip conductors used in the coupler; dielectric layers and shielding layers being removed for simplicity of understanding the orientation of such strip conductors.

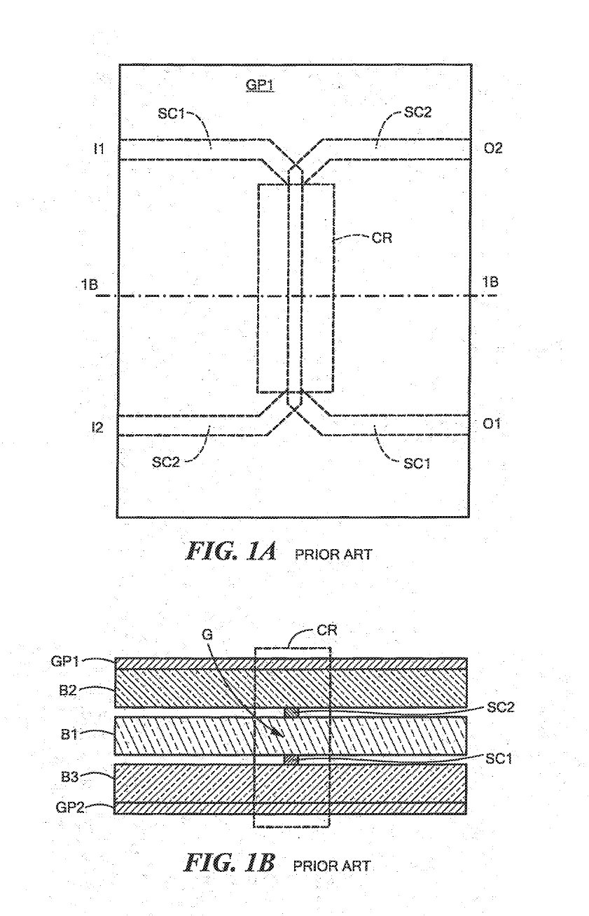

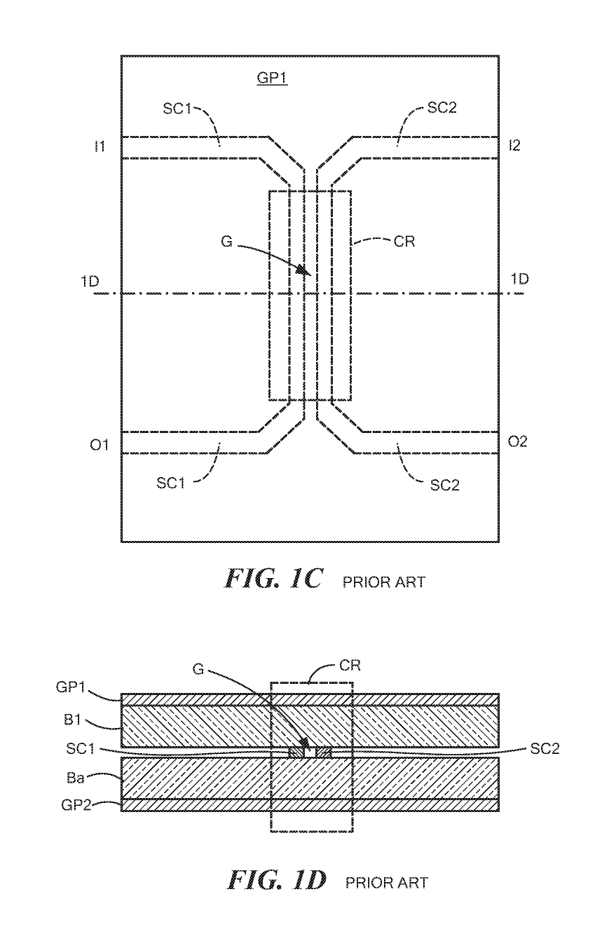

Like reference symbols in the various drawings indicate like elements.

### DETAILED DESCRIPTION

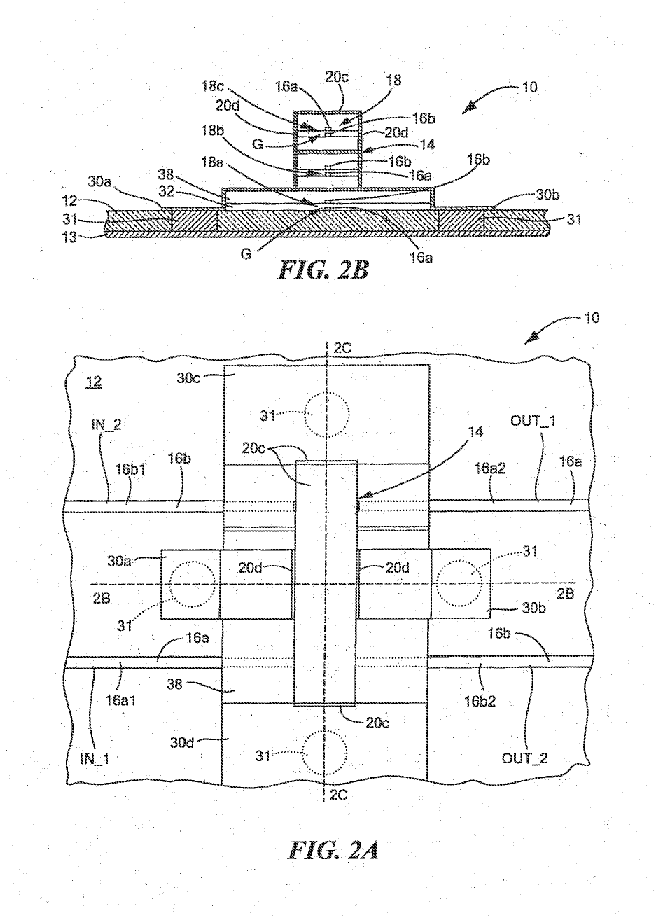

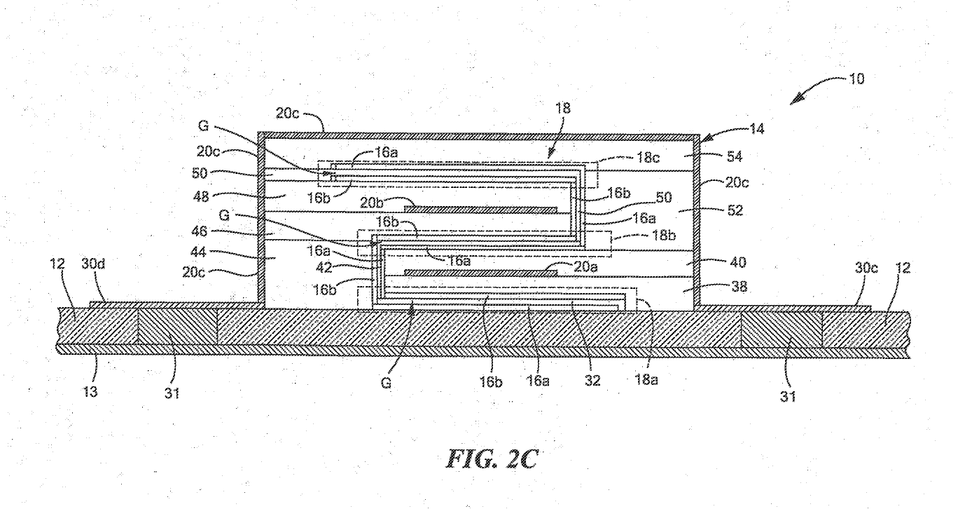

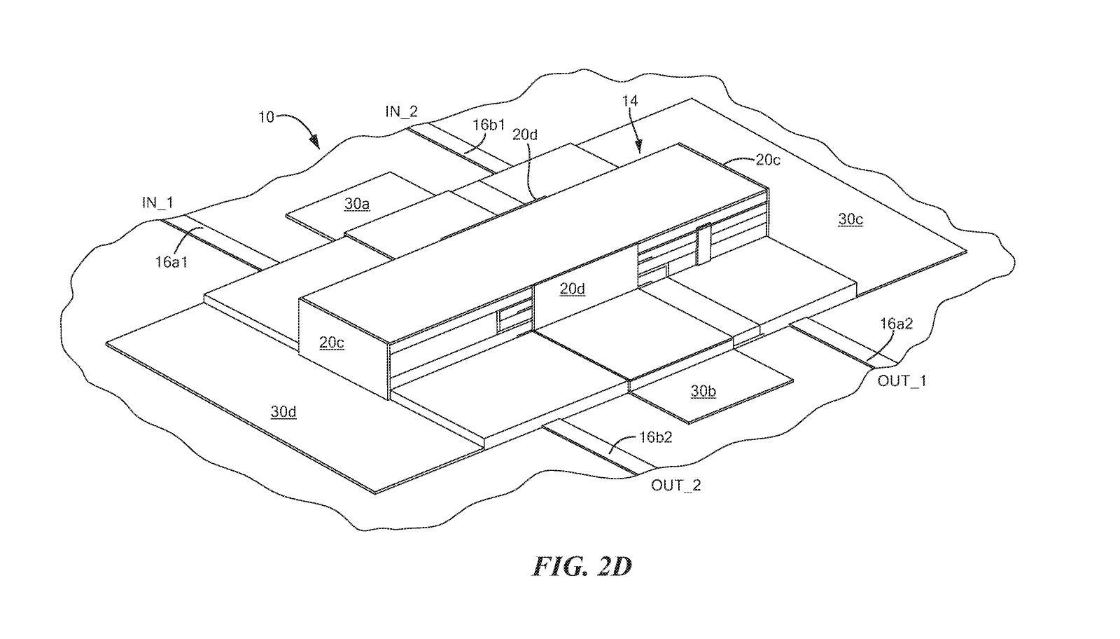

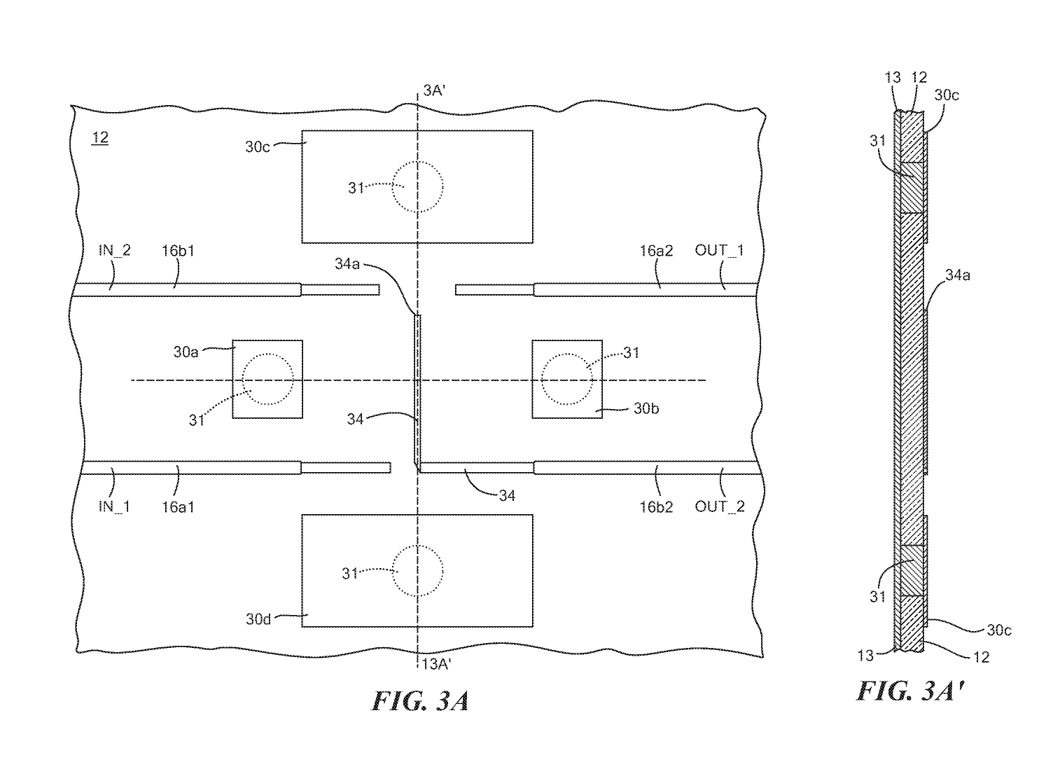

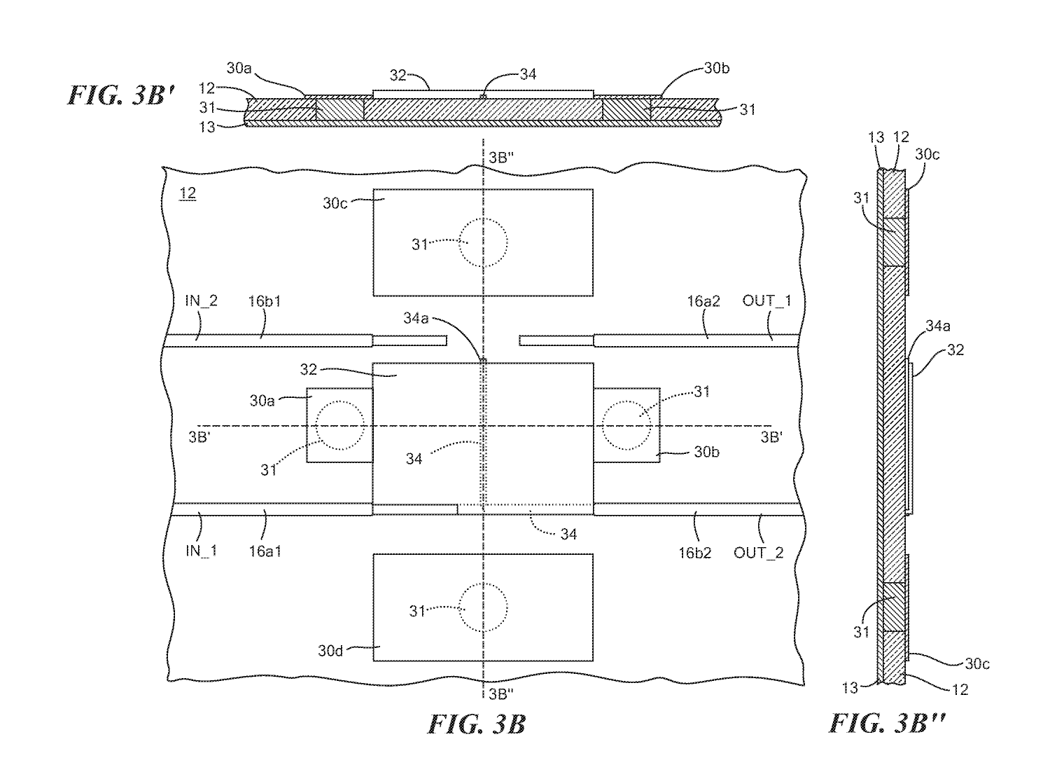

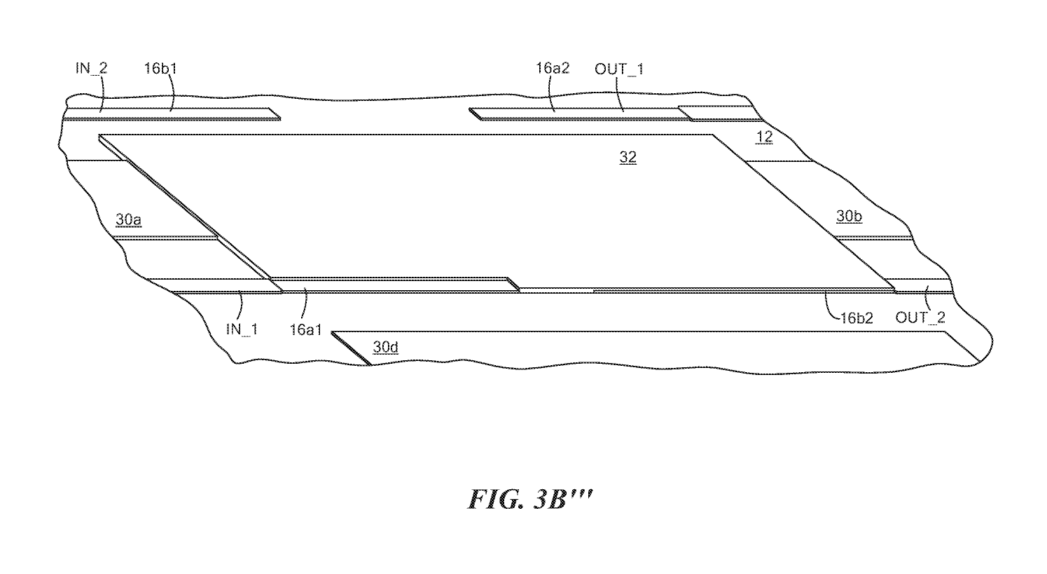

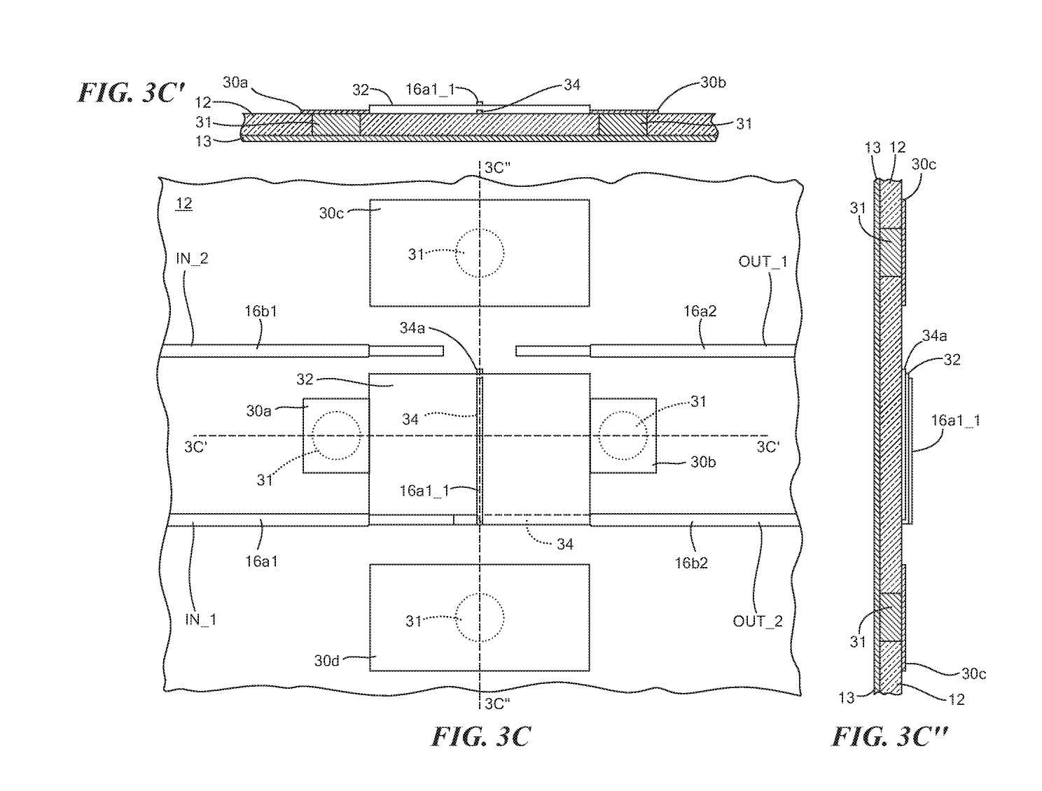

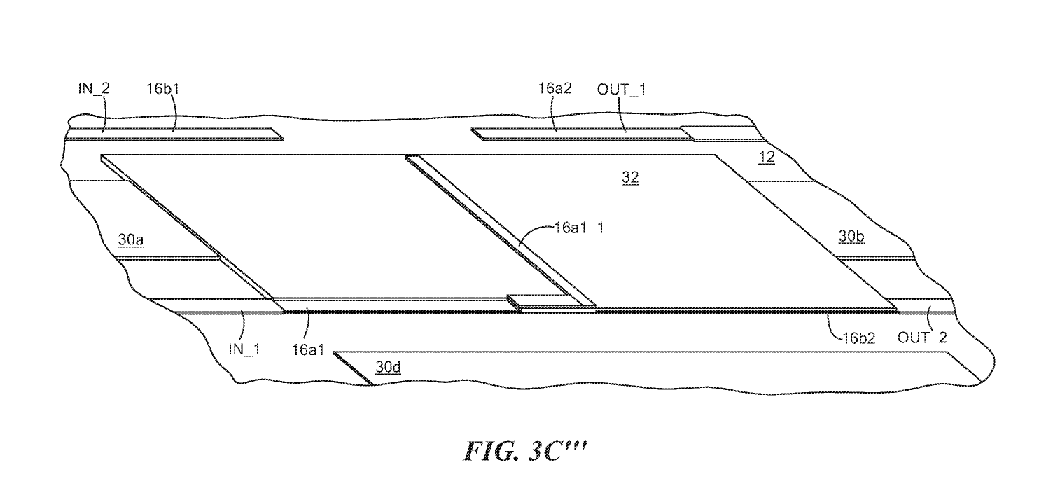

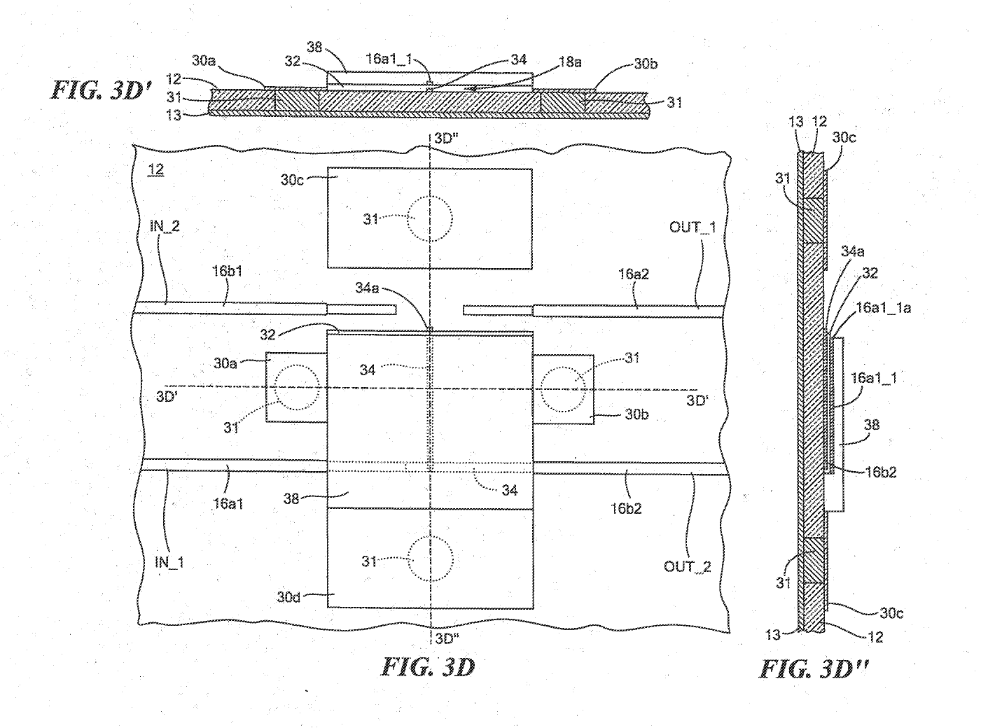

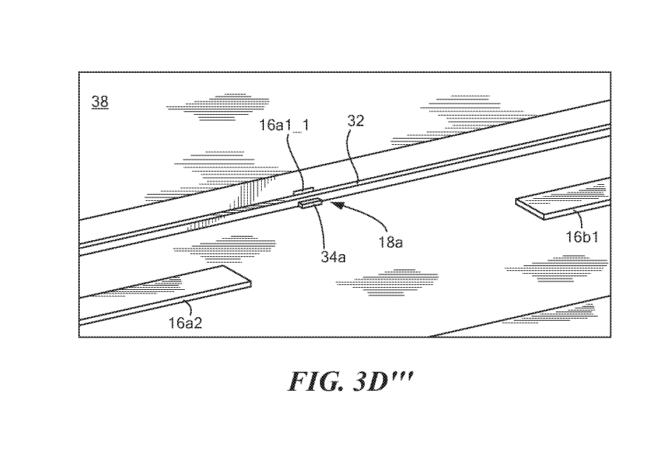

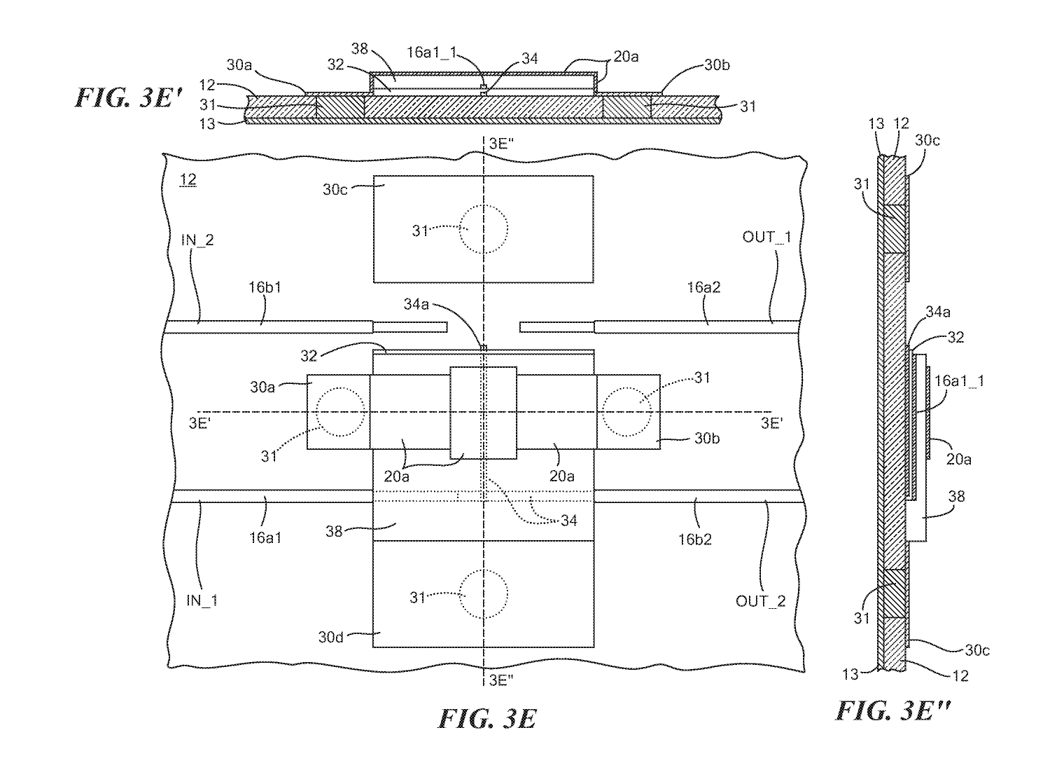

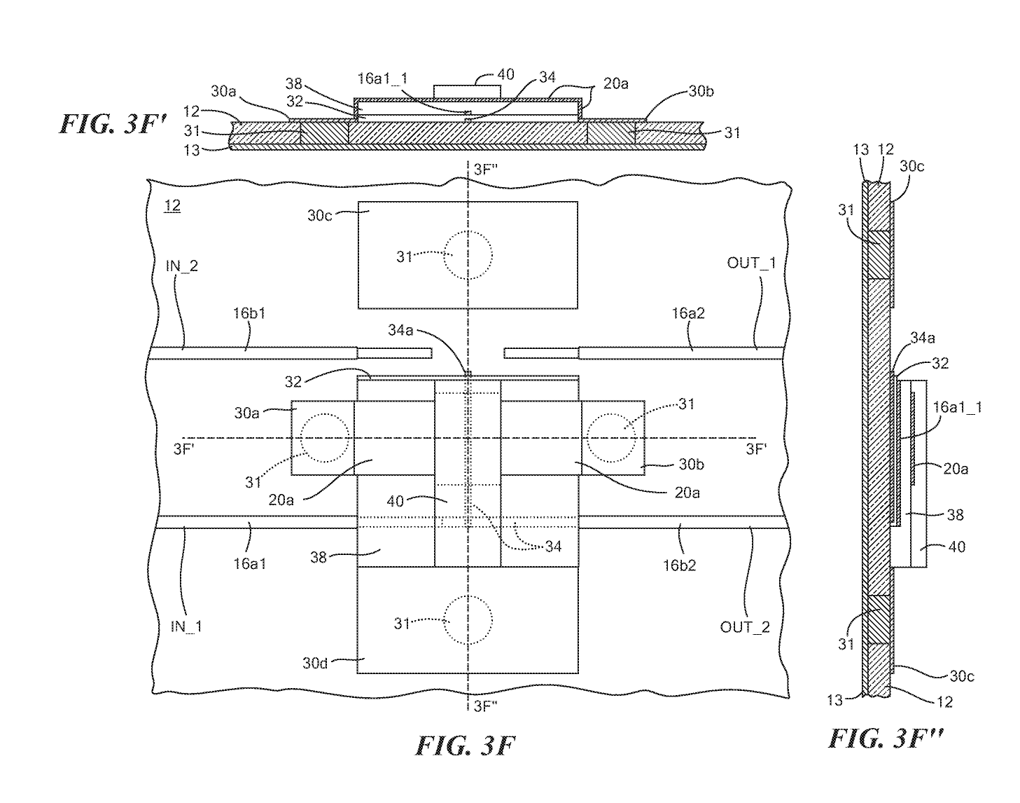

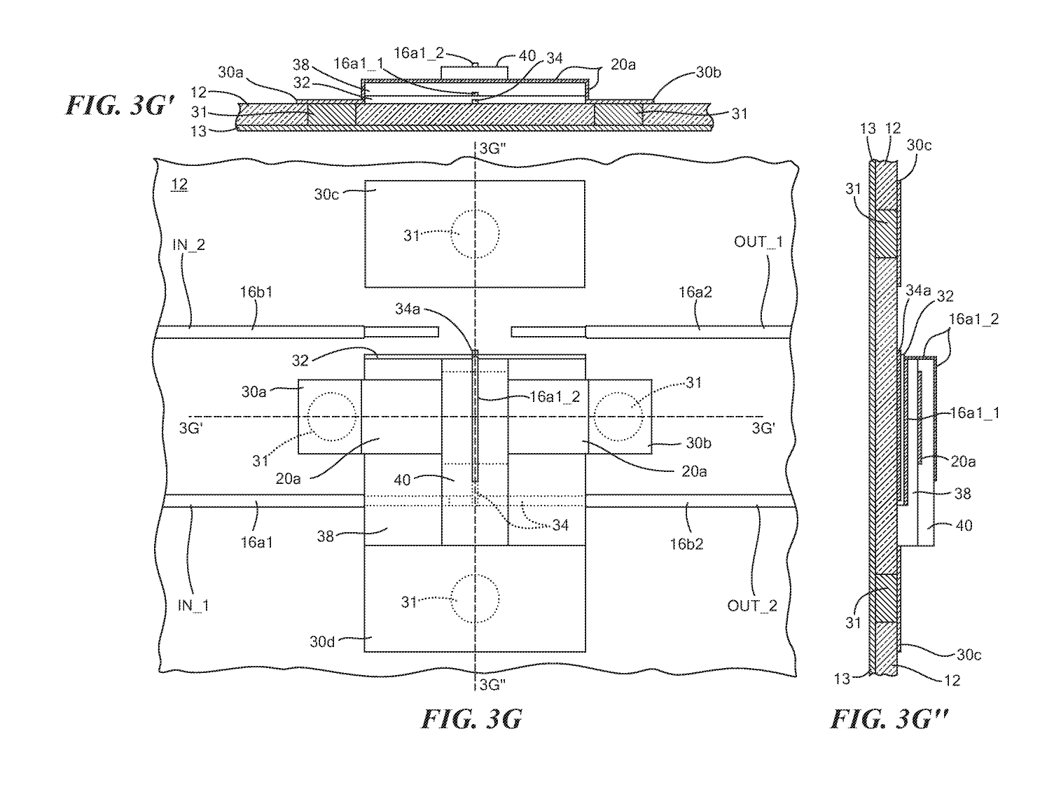

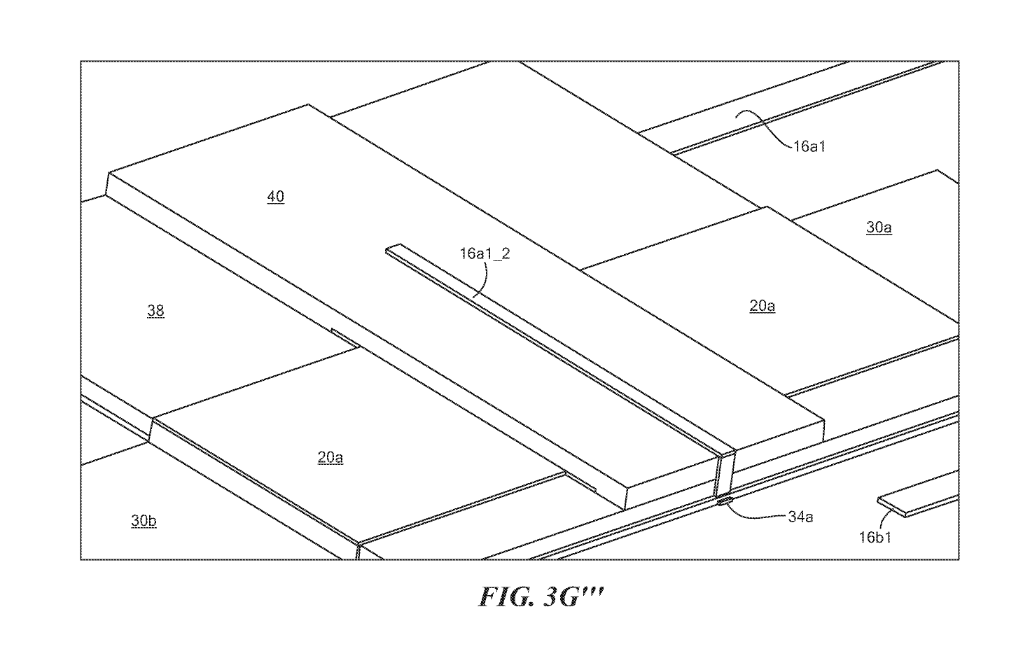

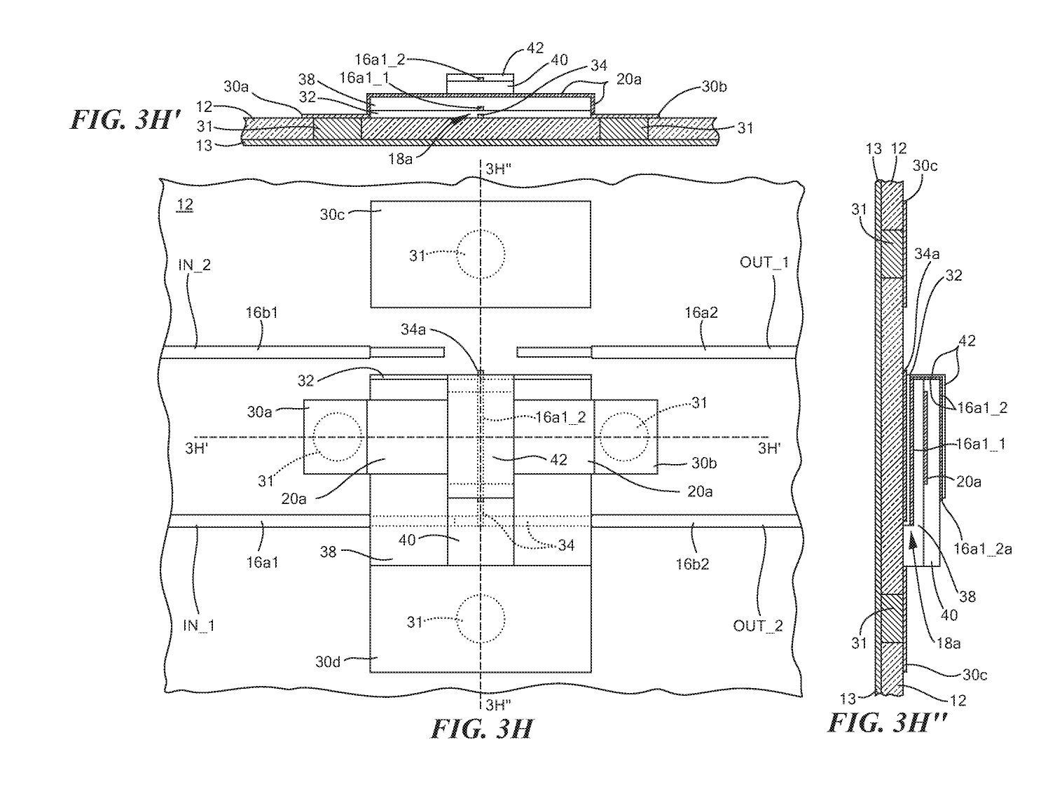

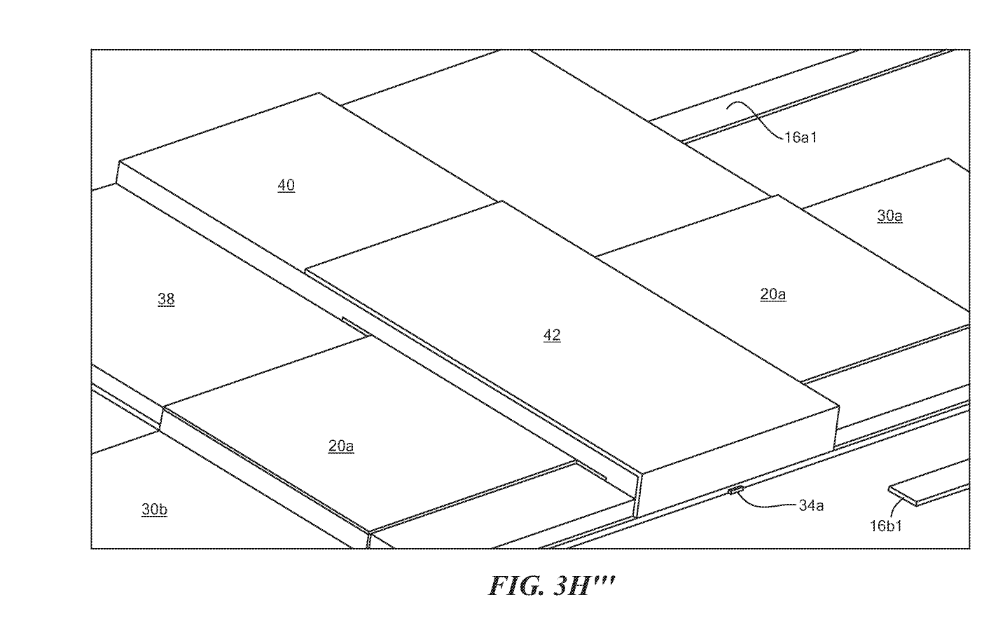

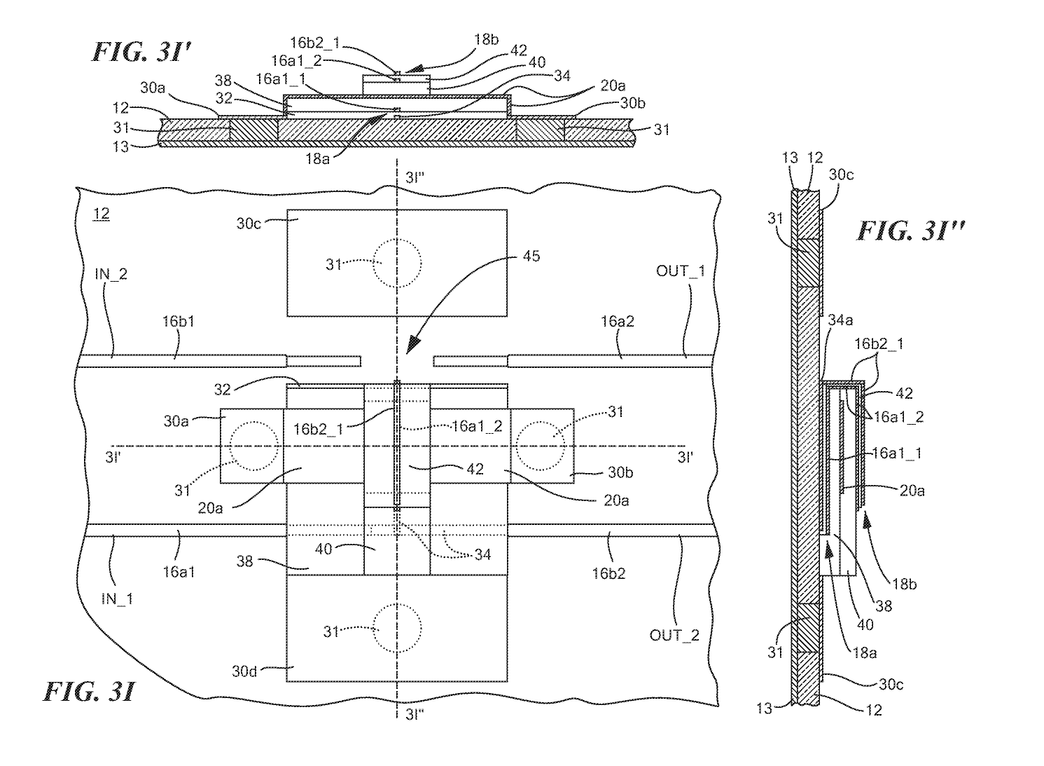

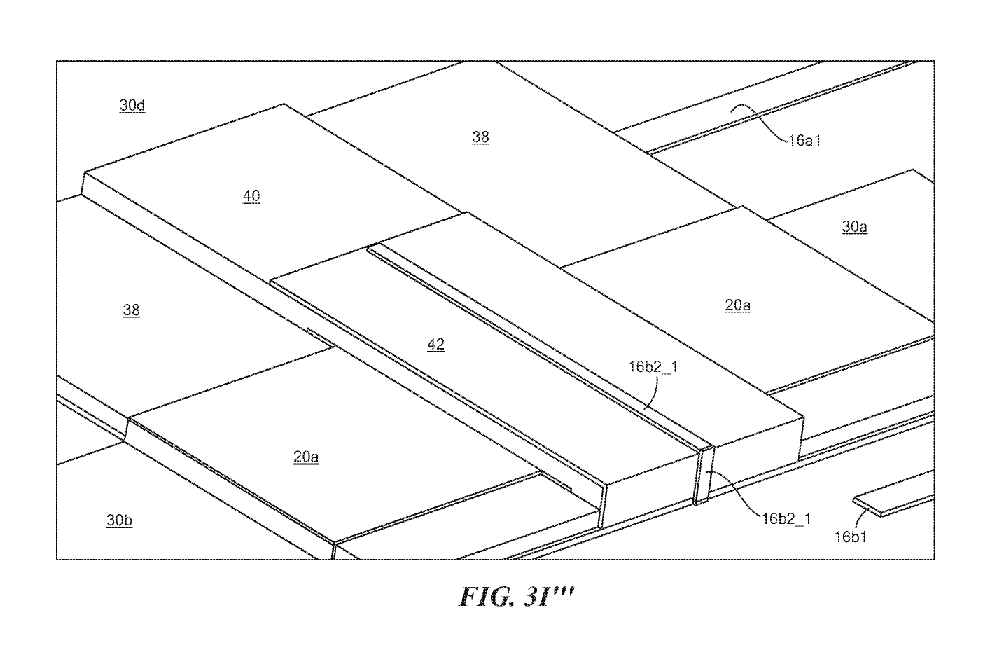

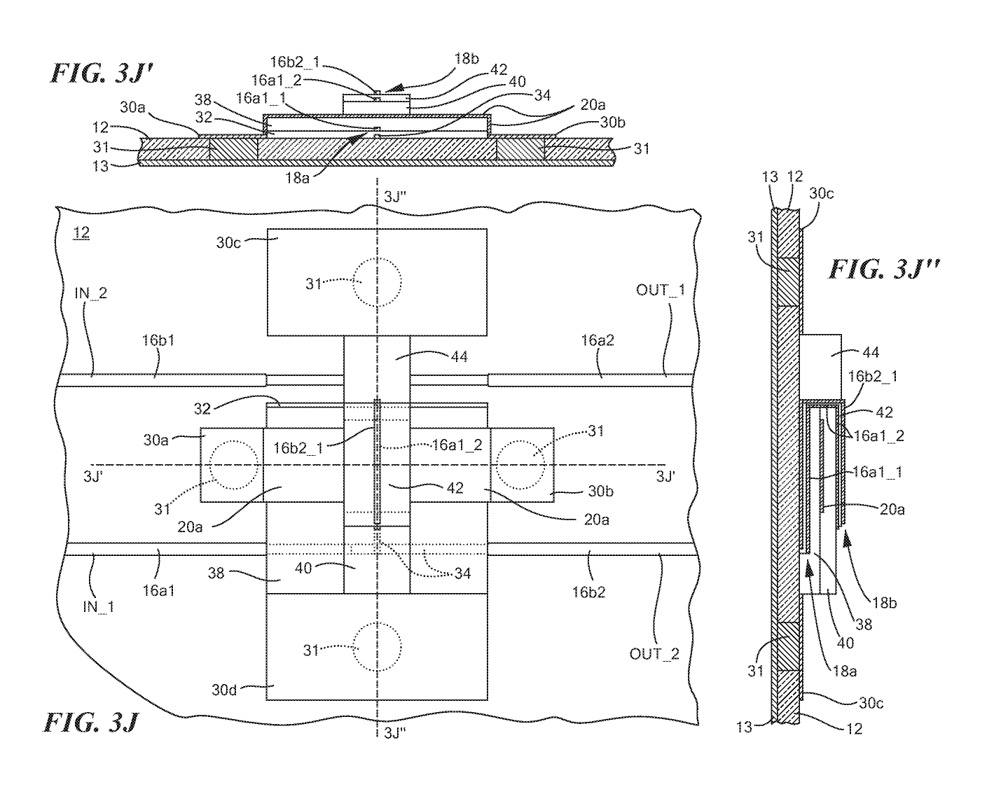

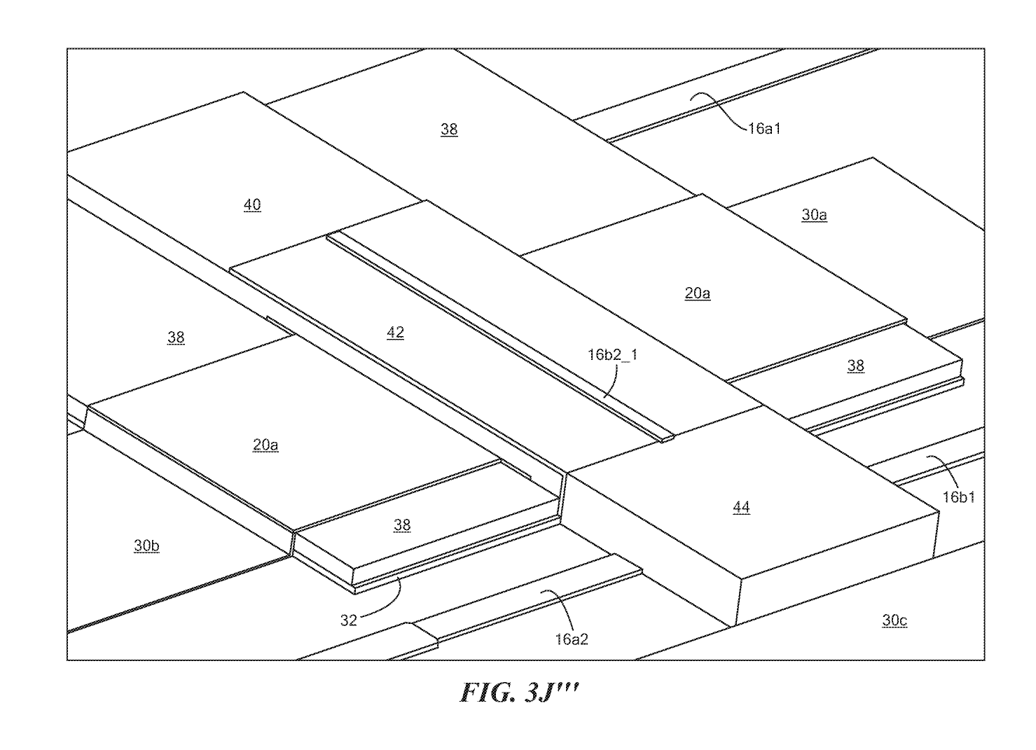

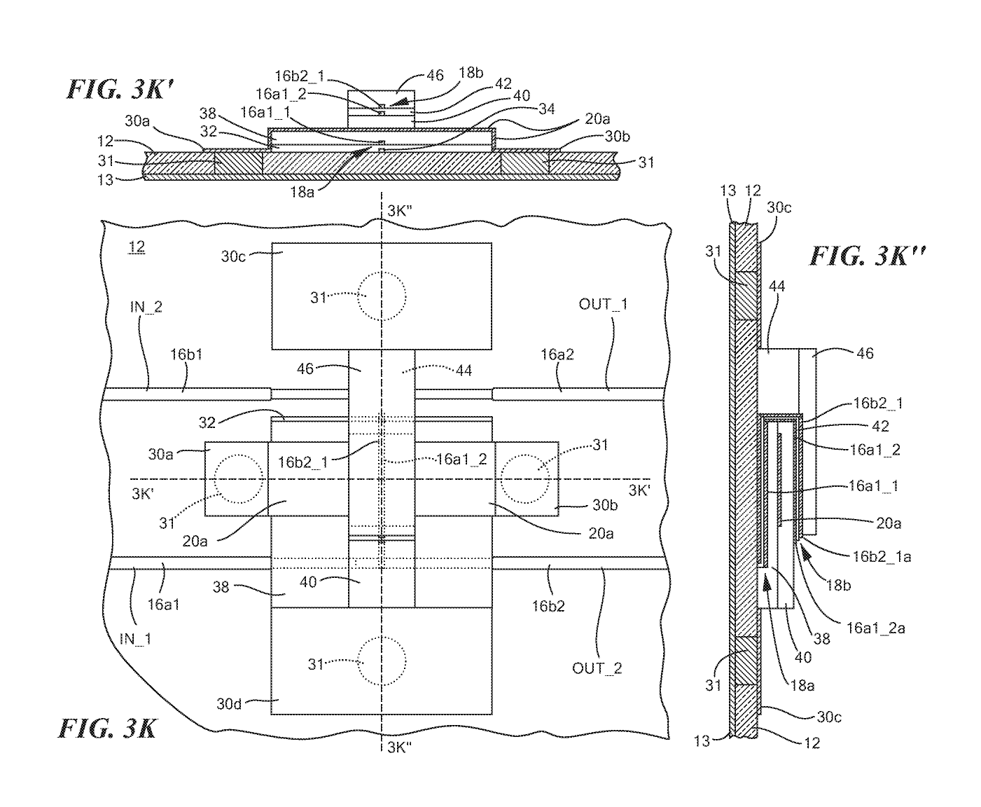

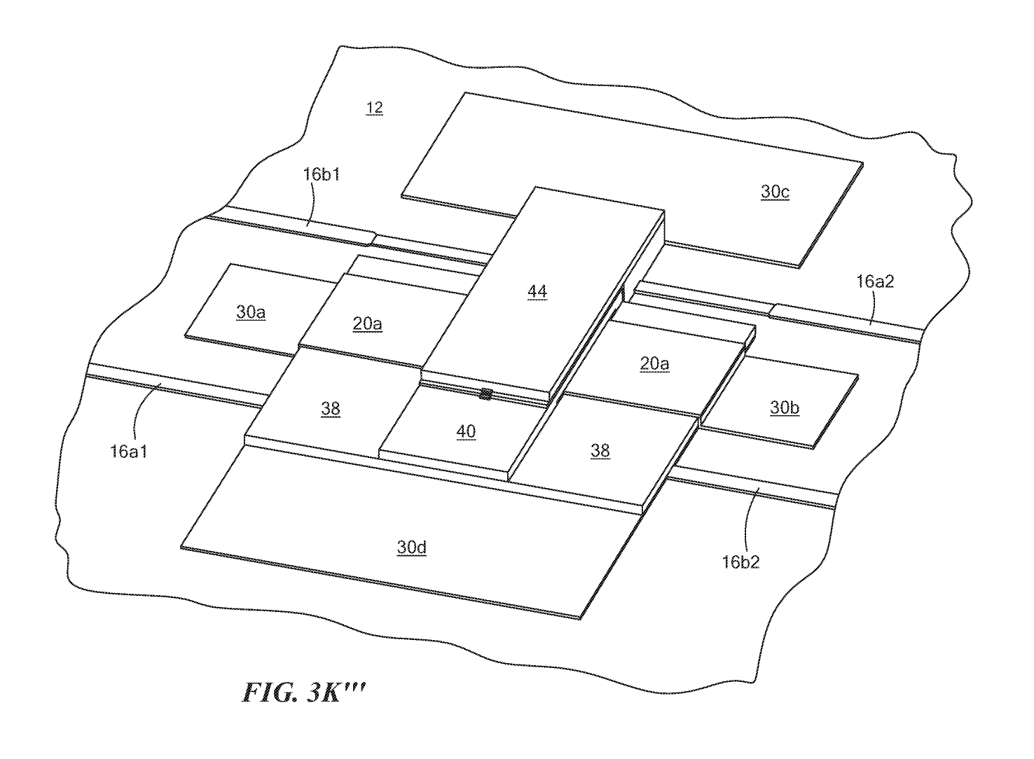

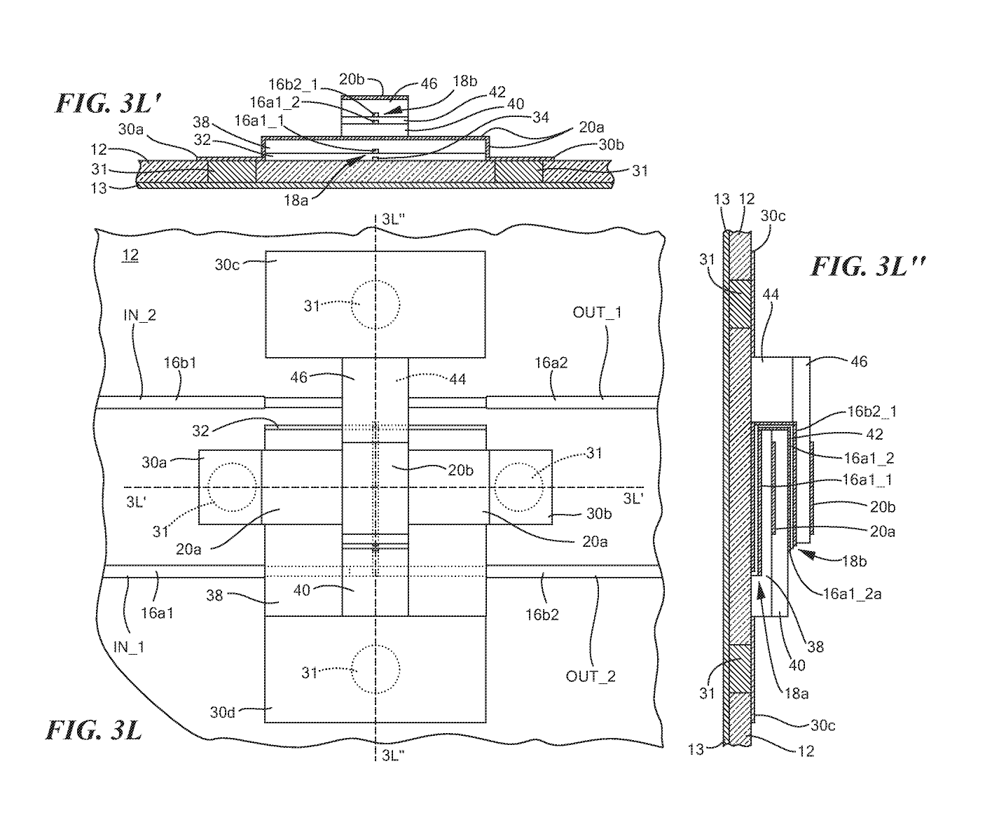

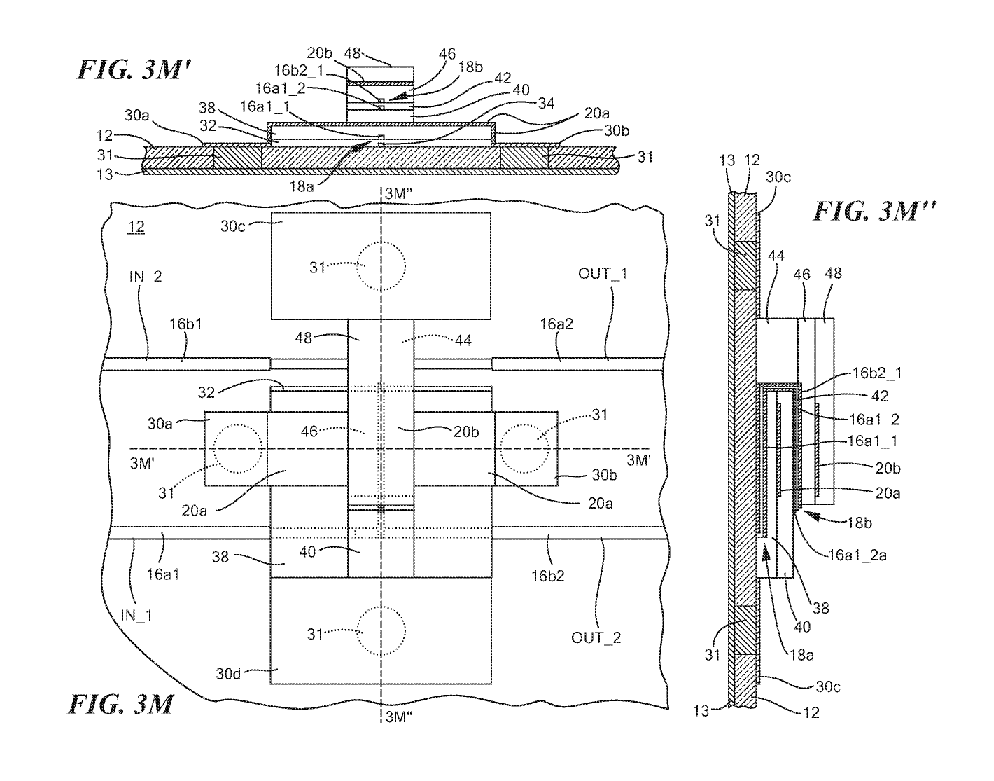

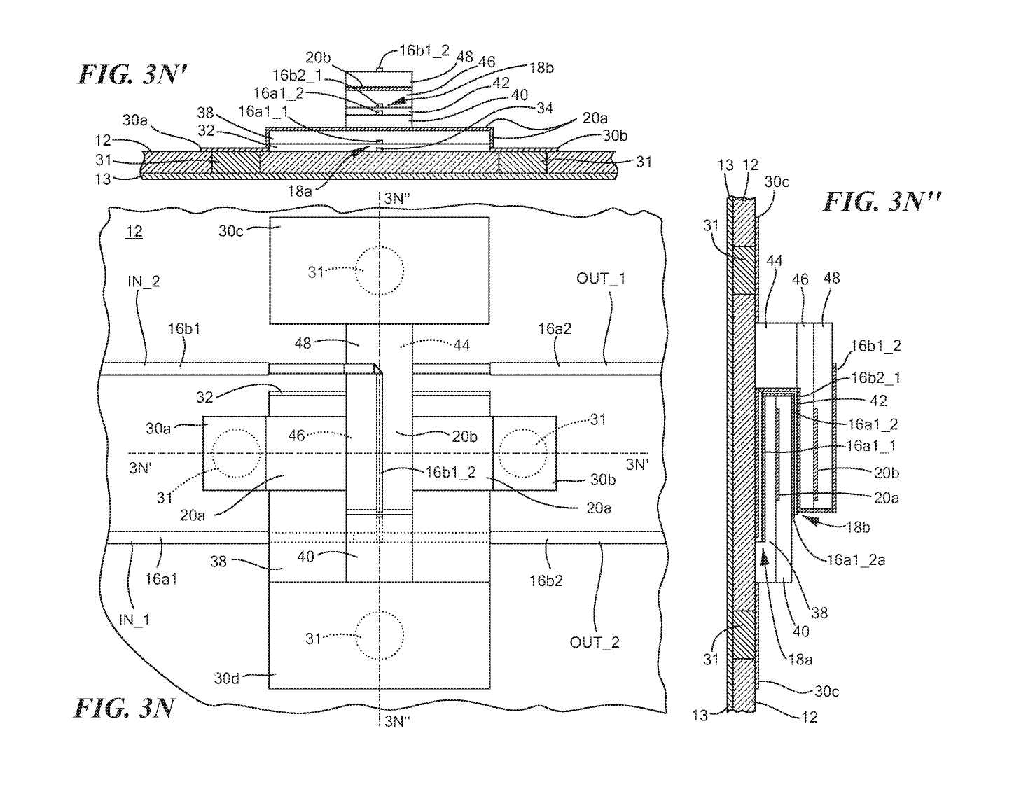

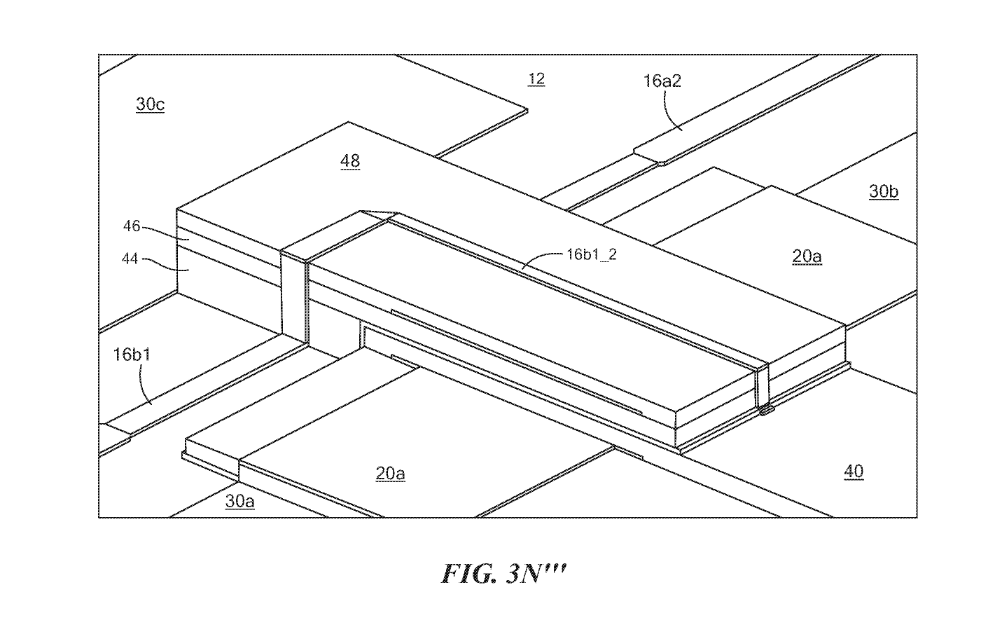

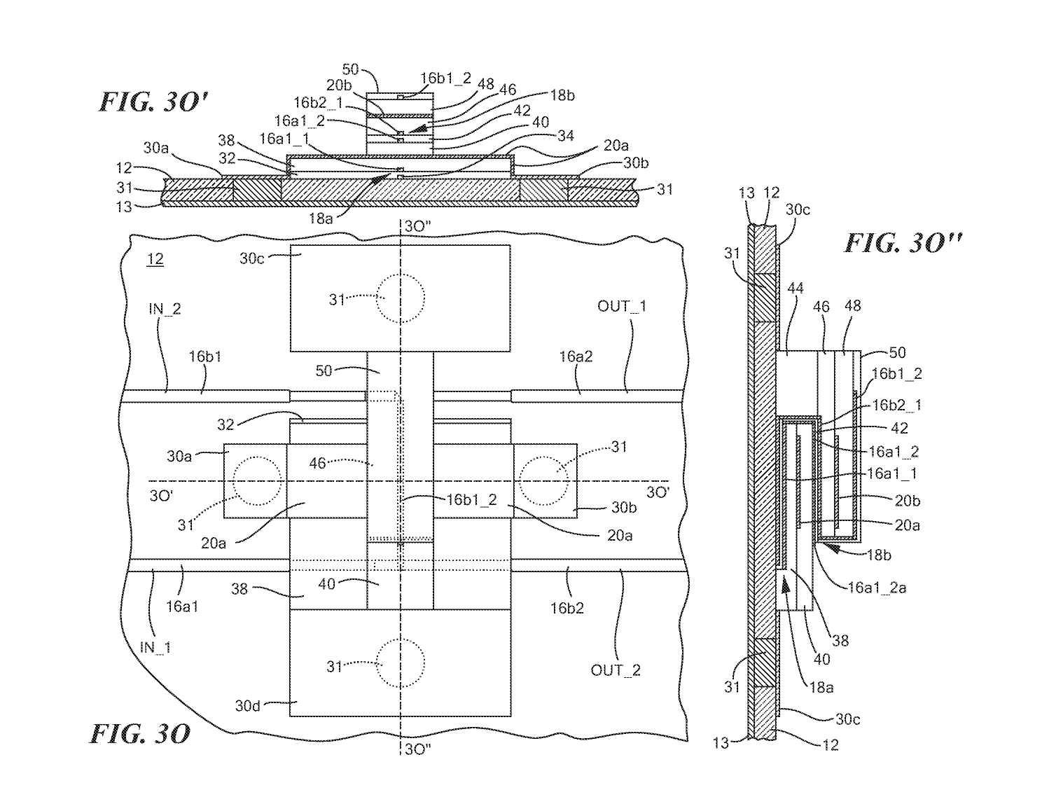

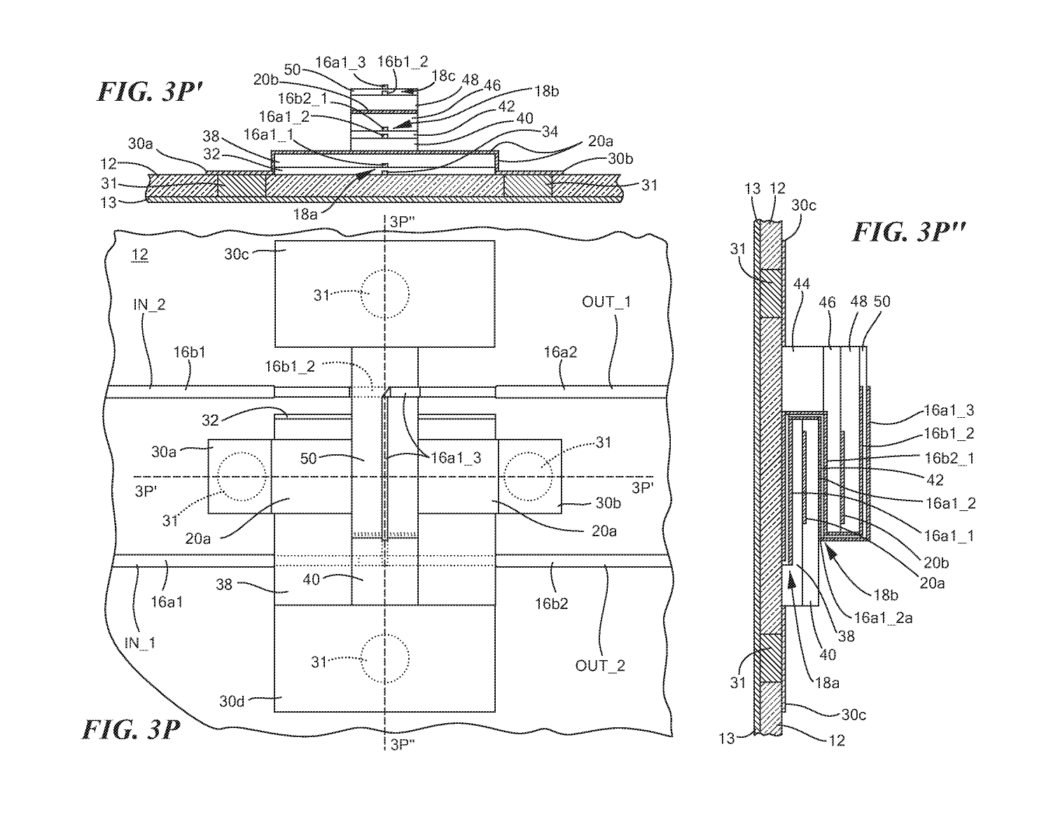

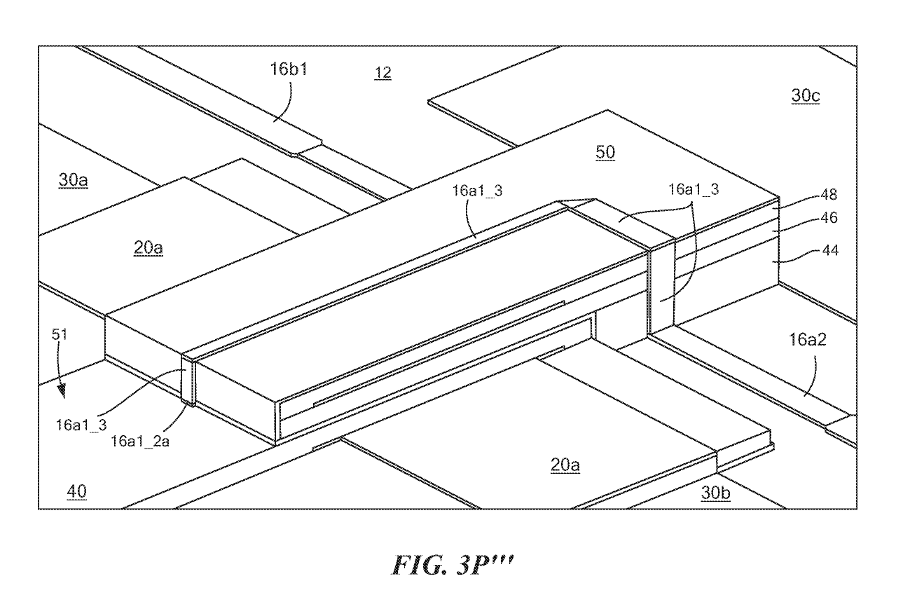

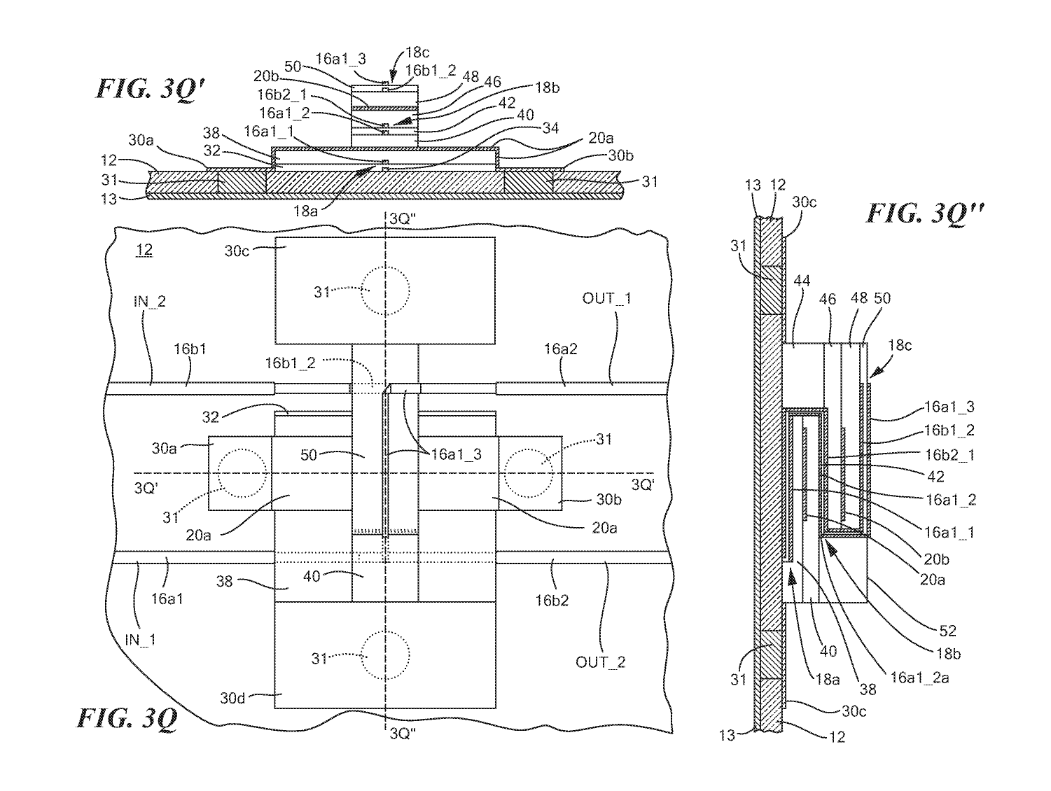

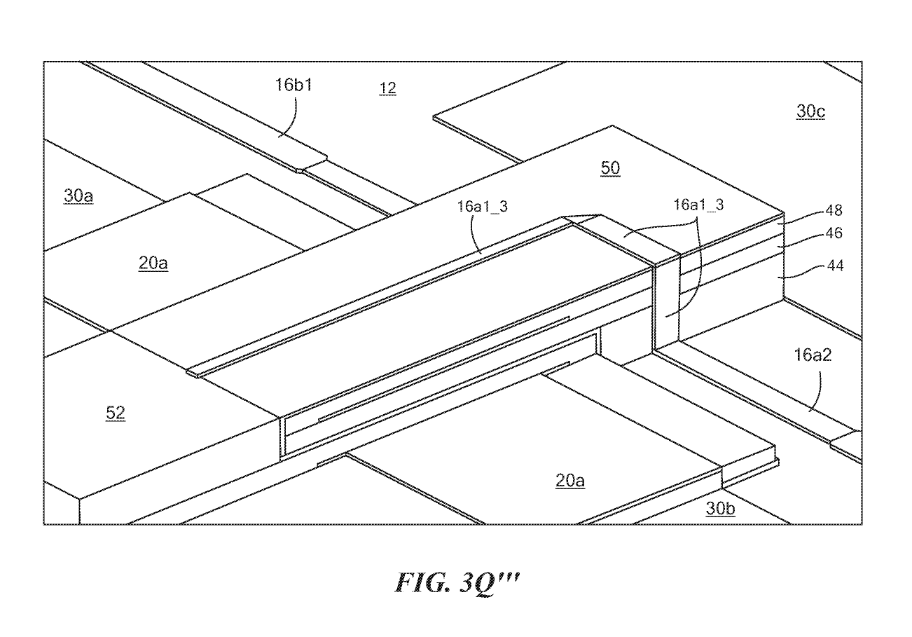

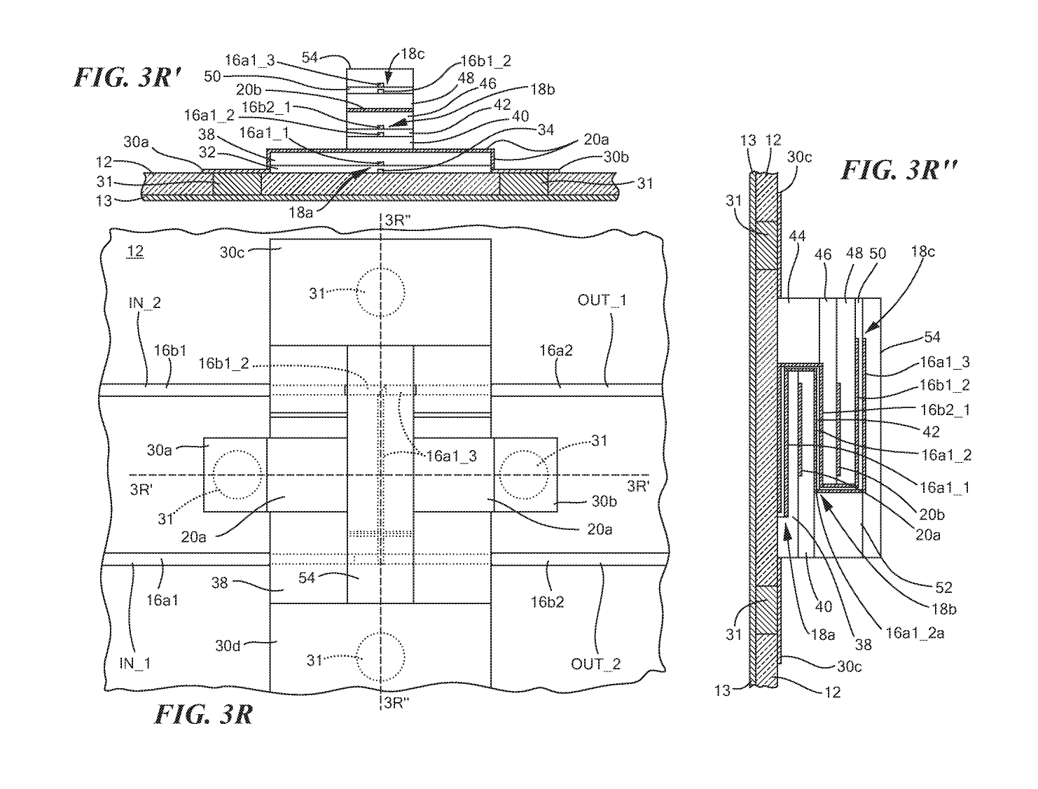

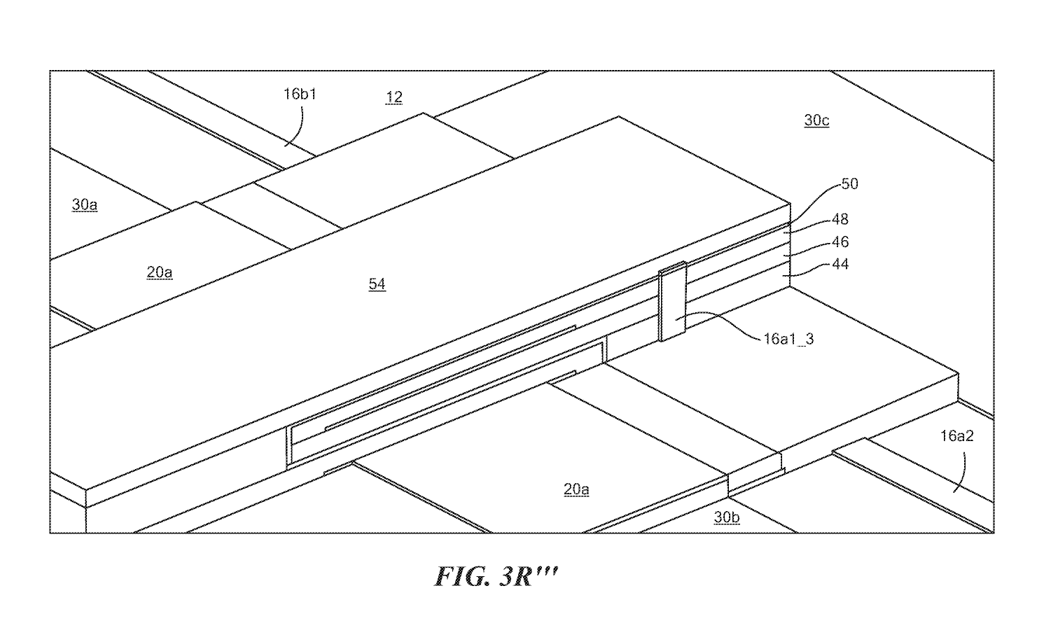

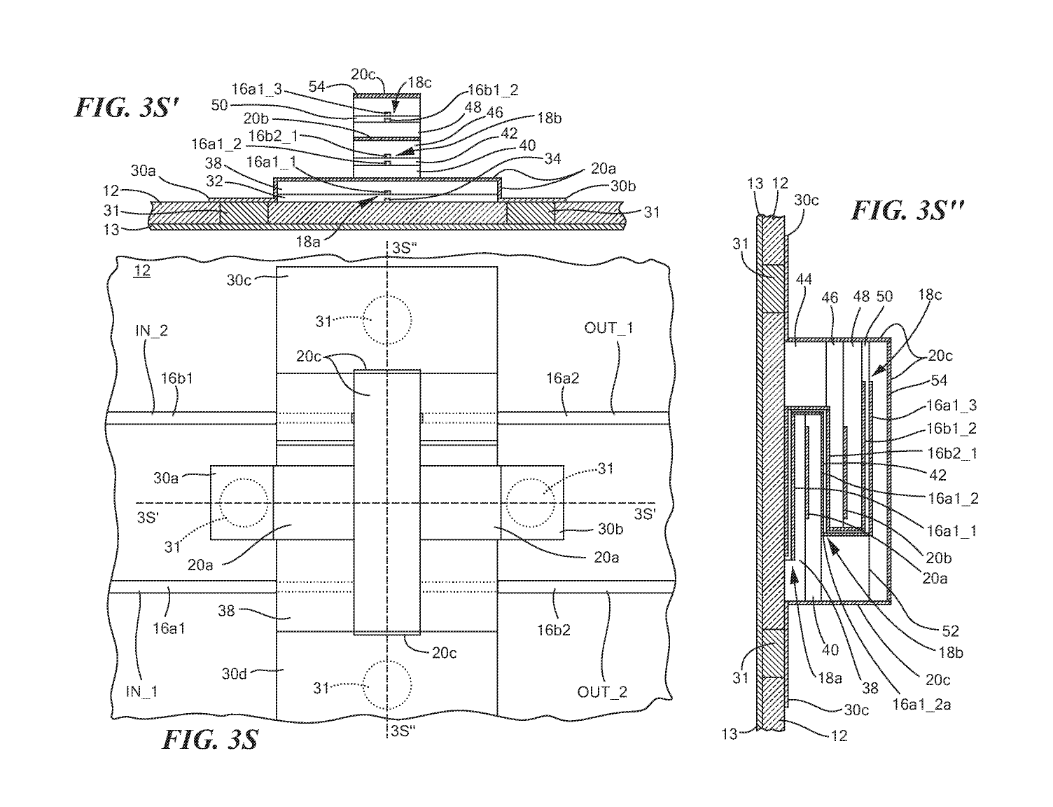

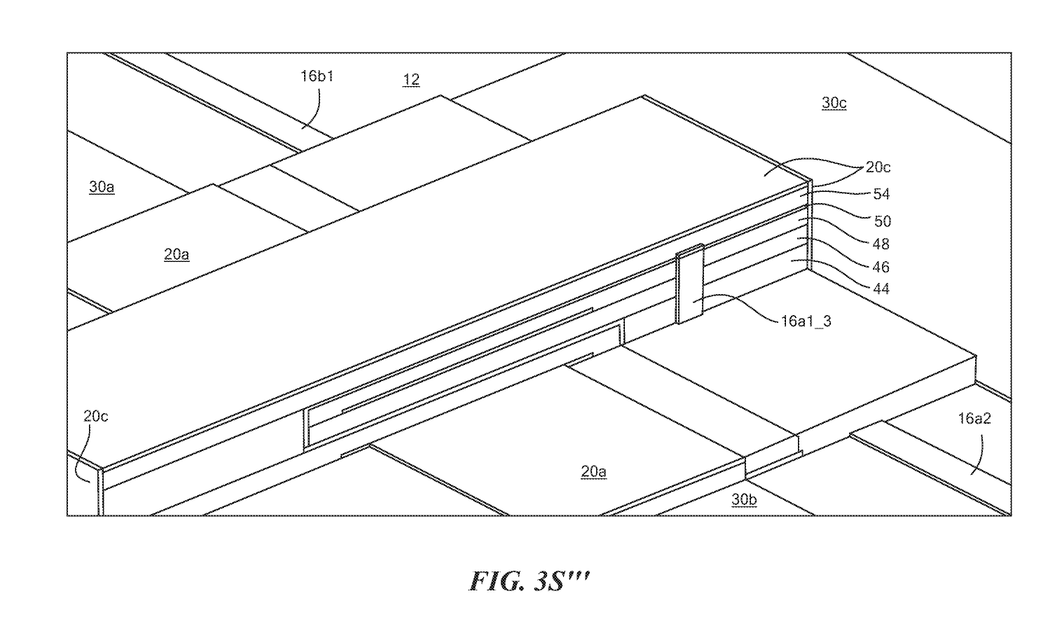

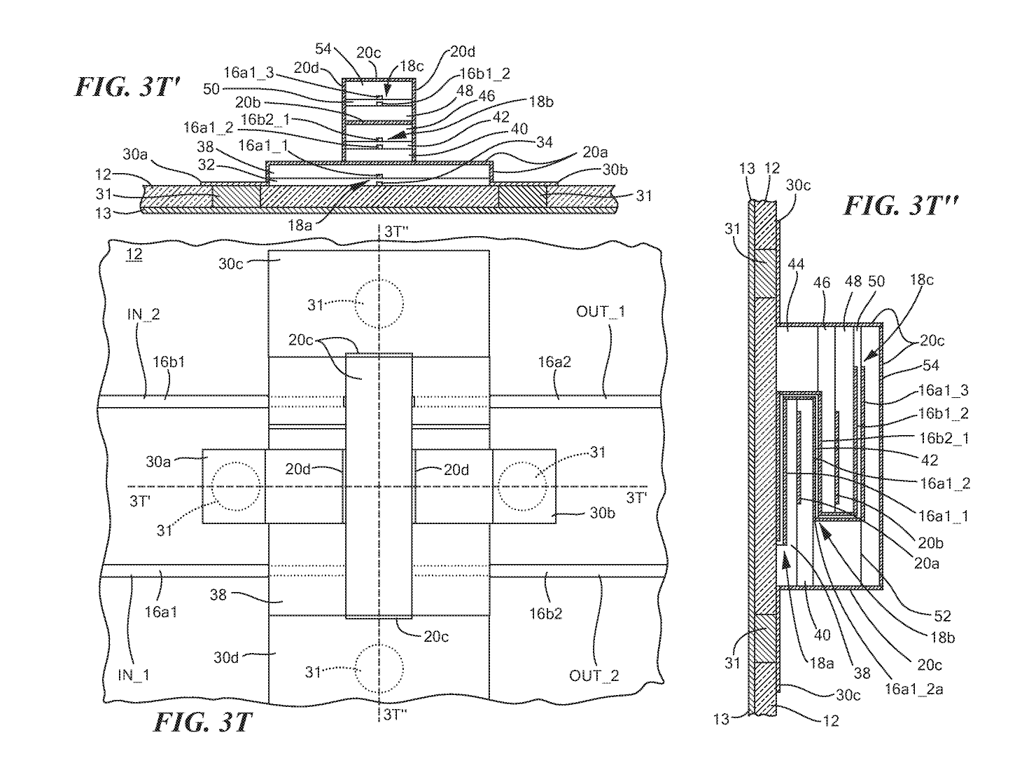

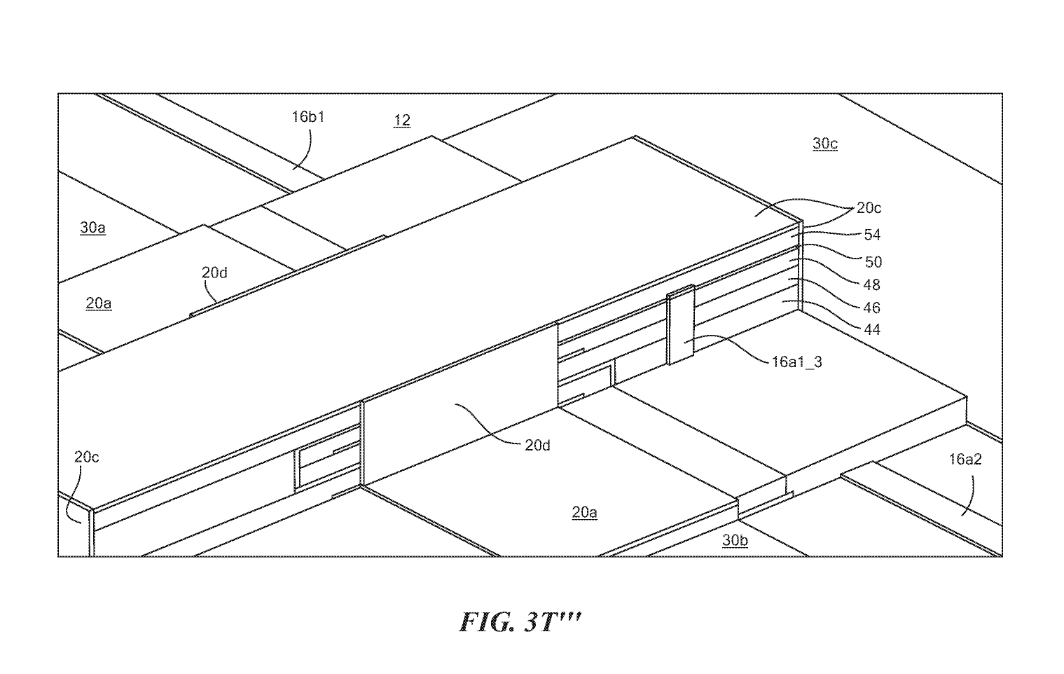

Referring now to FIGS. 2A-2D, a structure 10 is shown to include a dielectric substrate 12, having a ground plane conductor 13 on the bottom surface thereof and an RF coupler 14, here for example, a quadrature coupler, formed on an upper surface of the structure 10, at least in part, by additive manufacturing in a manner to be described in connection with FIGS. 3A-3T. Suffice it to say here that the structure 10 includes: (A) a pair of strip conductors 16a, 16b, which together with the ground plane conductor 13 and the dielectric substrate 12, provide a pair of microstrip transmission lines 16a, 16b having a pair of input ports IN_1, IN_2, respectively at one end thereof and having output ports OUT_1, OUT_2, respectively, at the opposite ends thereof, as shown; and (B) an RF coupler 14 providing an electromagnetic coupling region 18 for coupling: a portion of an input signal input port IN_1 to output port OUT_1 and another portion of the input signal at input port IN_1 to output port OUT_2; and one portion of an input signal at input port IN_2 to the output port OUT_2 and another portion of the input signal at input port IN_2 to the output port OUT_1.

More particularly, the electromagnetic coupling region 18 of the RF coupler 18 comprises a plurality of, here for example three, serially connected, vertically stacked, coupling sections 18a, 18b, and 18c; shown more clearly in FIGS. 2B and 2C. Each one of the coupling sections 18a, 18b and 18c includes adjacent portions of the pair of strip conductors 16a, 16b, disposed in an overlaying relationship in a vertical plane, and separated by a dielectric gap, G, the gap, G, forming an electromagnetic coupling region between the adjacent portions of the pair of strip conductors.

The RF coupler 18 includes two, horizontally disposed, electrically conductive layers 20a, 20b, each one of the electrically conductive layers 20a and 20c being disposed between a corresponding pair of the vertically stacked coupling sections 18a, 18b and 18c, as shown. More particularly, conductive layer 20a is disposed between coupling sections 18a and 18b and conductive layer 20b is disposed between coupling sections 18b and 18c. An electrically conductive layer 20c and 20d provides an upper or top cover for the RF coupler 14, and electrically conductive layer 20d provides sides for the RF coupler 14; it being noted that the electrically conductive layers 20a-20 are electrically interconnected one to the other and are electrically connected to conductive pads 30a-30; such conductive pads 30a-30d being electrically connected to the ground plane conductor 13 by electrically conductive vias 31 passing vertically through the substrate 12.

More particularly, conductive layer 20a provides electromagnetic shielding between the coupling sections 18a and 18b and electrically conductive layer 20b provides electromagnetic shielding between the coupling sections 18b and 18c. The RF coupler 14 includes the additional electrically conductive layer 20c is disposed over an upper most one of the serially connected, vertically stacked, coupling sections 18a-18c; here coupling section 18c, as shown to contribute to electromagnetic shielding for the RF coupler. Electrically conductive layer 20d is connected to conductive layers 20a-20c to provide an electrically conductive shield on all four sides of the vertically stacked, coupling sections 18a-18c; portions of conductive layers 20c being on opposite sides of one another and portions of layer 20d being on being on opposite sides of one another. The plurality of electrically conductive layers, 20a-20d is electrically interconnected to form an electrical shield 22 around the coupling sections 18a-18c.

It is noted that the various conductive layers 20a-20d and portions of the strip conductors 16a, 16b of the RF coupler 18 are separated (electrically insulated) one from the other by various dielectric layers 32, 38, 40, 42, 44, 46, 48, 50, 52, and 54, to be described below in connection with FIG. 3A-3T.

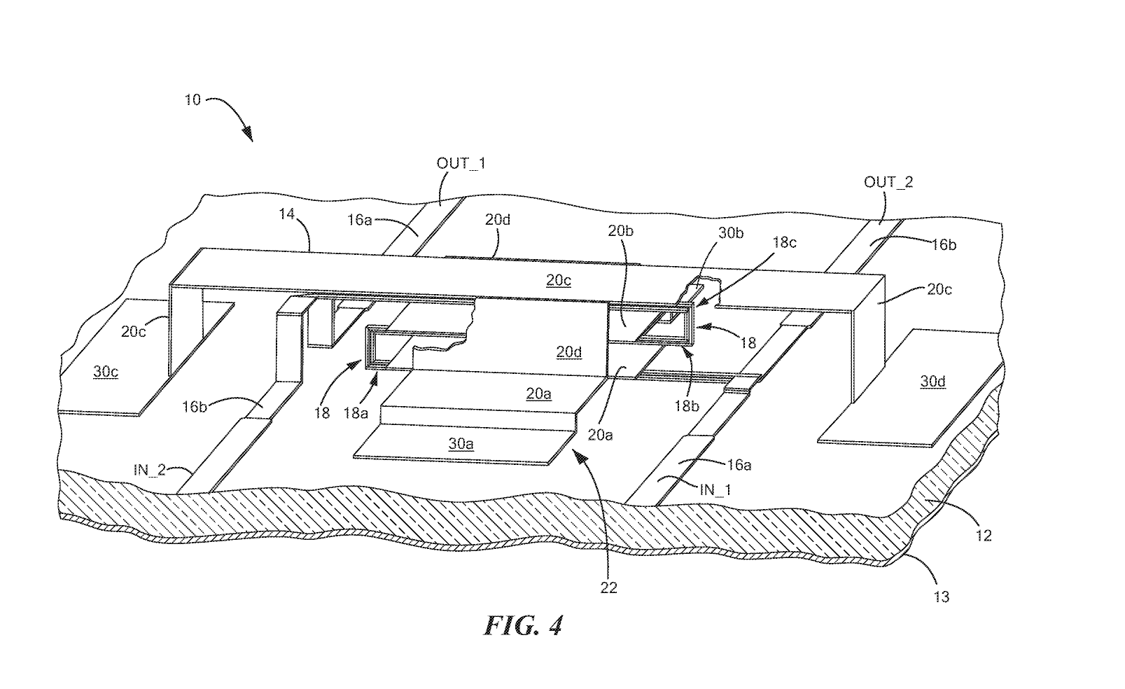

Referring now to FIG. 4, FIG. 4 is a perspective sketch of portions of the coupler of FIG. 2A with dielectric layers thereof being removed and a portion of one of the electrically conductive layers thereof partially broken away for simplicity in understanding the orientation of other shown portions of the coupler.

Referring now to FIGS. 3A-3T the process for forming the structure 10 will be described. Thus, referring to FIGS. 3A and 3A′, the upper surface of the substrate 12, with the ground plane conductor 13 on the bottom thereof, has a pattern of conductive elements formed thereon for example by etching a sheet of conductive material or by a 3D printing or additive manufacturing, to form: ground plane conductive pads 30a, 30b, 30c and 30d connected to the ground plane conductor 13 (FIG. 2A) by electrically conductive vias 31, as indicated; portions 16a₁ of the strip conductors 16a; portions 16a₂ of the strip conductors 16a; portions 16b₁ of the strip conductors 16b; and portions 16b₂ of the strip conductors 16b.

Referring now to FIGS. 3B, 3B′, 3B″ and 3B′″, a dielectric layer 32 is 3D printed over the area of the surface of the substrate 12 where the coupling region 18 is to be formed; a portion of the dielectric layer 32 being disposed on portions 34 of the portions 16b₂ of the strip conductor 16b, as shown; it being noted that an end portion 34a of the portion 16b₂ of the strip conductor 16b remaining uncovered by the dielectric layer 32.

Referring now to FIGS. 3C, 3C′, 3C′″ and 3C′″, using a conductive ink, a conductive strip portions 16a1_1 of strip conductor 16a are printed on a vertical edge of the dielectric layer 32 and up and onto the surface of the dielectric layer 32 to connect conductive strip portions 16a1 to portion 16a1_1; it being noted that conductive strip portions 16a1_1 is printed vertically over the portion 34 of strip conductive 16b₂ (FIG. 3A) but separated by portions of the dielectric layer 32 (FIG. 3B) layer thereby forming the coupling section 18a; it being again noted that end portion 34a of the portion 16b₂ of the strip conductor 16b, remains uncovered by the dielectric layer 32.

Referring to FIGS. 3D, 3D′, 3D″ and 3D′″, a dielectric layer 38 is 3D printed over the first coupling section 18a leaving an outer edge 16a1_1a of conductive strip portion 16a1_1 exposed; it being remember that end portion 34a of the portions 16b₂ of the strip conductor 16b remain uncovered by the dielectric layer 32.

Referring now to FIG. 3E, 3E′, 3E″ conductive layer 20a is printed onto the top of dielectric layer 38 and over the sides (vertical edges of) the dielectric layers 32 and 38 onto the pads 30a, 30b, as shown.

Referring to FIGS. 3F, 3F′ and 3F″, a dielectric layer 40 is printed over portions of the conductive layer 20a on the upper surface while leaving side portions 20a of layer 20a exposed, as shown.

Referring to FIGS. 3G, 3G′, 3G″ and 3G′″, conductive layer 16a1_2 is printed onto the surface of dielectric layer 40 and over the outer, vertical edges of dielectric layers 38 and 40 and onto edge 16a1_1a to connect the conductive layer 16a1_1 to conductive layer 16a1_2.

Referring to FIGS. 3H, 3H′, 3H″ and 3H′″, a dielectric layer 42 is printed over the conductive layer 16a1_2 and over the vertical side of such conductive layer 16a1_2, as shown. It is noted that end 16a1_2a of strip 16a1_2 is left exposed as shown.

Referring to FIGS. 3I, 3I′, 3I″, and 3I′″, a conductive strip 16b2_1 is printed over dielectric 42 and aligned vertically over conductive strip 16a1_2 to form the second coupling section 18b; it being noted that such conductive material 16b2_1 is printed over the portions of the dielectric layer both on the upper surface and side of the structure shown in FIG. 3I′″ with a portion of the conductive strip 16b2_1 being printed on the edge portion 34a of the portion 34 of strip conductor 16b2 thereby connecting strip conductor 16b2_1 strip conductor 16b2 serially connecting coupling section 18a to coupling section 18b. It is noted that end 16a2_1a of strip conductor 16a2_1 remains exposed by both the strip conductor 16b2_1 and the dielectric layer 42.

Referring to FIGS. 3J, 3J′, 3J″, and 3J′″, a dielectric layer 44 is printed to fill a space 45 (FIG. 3I) on the surface next to previously printed sections of substrate 12, as shown. This dielectric layer 44 should be printed to same height of the dielectric layers next to it to form a level dielectric surface for subsequent processing of the coupling region.

Referring to FIGS. 3K, 3K′, 3K″ and 3K″, a dielectric layer 46 is printed on the structure shown in FIG. 3J thus formed leaving ends 16a1_2a and 16b2_1a of strip conductors 16a1_2 and 16b2_1, respectively, exposed, as shown.

Referring to FIGS. 3L, 3L′ and 3L″, the conductive layer 20b is printed on top of the middle portion of dielectric layer 46, as shown.

Referring to FIGS. 3M, 3M′ and 3M″, a dielectric layer 48 is printed on the surface of the structure shown in FIG. 3L thus formed over conductive layer 20b, as shown.

Referring to FIGS. 3N, 3N, 3N″ and 3N′″, a conductive strip 16b1_2 is printed on the end of strip conductor 16b1, up and along the sides of dielectric layers 44, 46 and 48 along the upper surface of dielectric layer 48 and then down the sides of dielectric layers 48 and 46 to connect with the end 16b2_1a of strip conductor 16b2_1, as shown.

Referring to FIGS. 3O, 3O′ and 3O″, a dielectric layer 50 is printed on top of the structure shown in FIG. 3N over the portion of strip conductor 16b2_1 on the upper surface of dielectric layer 48 and over the portion of the strip conductor 16b2_1 along the sides of dielectric layers 48 and 46, as shown.

Referring to FIGS. 3P, 3P′, 3P′ and 3P″, a conductive strip 16a1_3 is printed on the edge 16a1_2a of strip conductor 16a1_2, along the vertical sides of dielectric layer 50 along the upper, horizontal surface of dielectric layer 50 vertically aligned over the strip conductor 16b2_1 on the surface of dielectric layer 48, forming the third coupling section 18c, and then down the sides of dielectric layers 50, 48, 46 and 44 to connect with the end of strip conductor 16a2 which is on the surface of the substrate 12, as shown.

Referring to FIGS. 3Q, 3Q′, 3Q″ and 3Q′, a dielectric layer 52 is printed to fill space 51 (FIG. 3P) to provide a level surface as across the coupling region being formed, as shown.

Referring to FIGS. 3R, 3R′, 3R″, and 3R′″, dielectric layer 54 is printed as shown to cover both the horizontal portion and vertical portion of the strip conductor 16a1_3 on the top and vertical sides of the structure shown in FIG. 3Q while exposing strip conductors 16a1, 16b1, 16a2 and 16b2, as shown.

Referring to FIGS. 3S, 3S′, 3S″ and 3S′, the conductive layer 20c is printed on the upper surface and vertical sides of the structure as shown in FIG. 3S and onto conductive pads 30c and 30d, as shown.

Referring now to FIGS. 3T, 3T′ 3T″ and 3T′″, a conductive layer 20d is printed on the upper surface of and a pair of opposing sides of the structure shown in FIG. 3S and onto conductive pads 30a and 30b and onto edges of layers 20a, 20b, connecting to conductive pads 30a, 30b, as shown thereby completing shield 22 for the coupler 10. It is noted that the conductive pads 30a-30d may be connected to the ground plane by conductive vias 31, passing through the substrate or by printing a conductor around sides of the substrate between the conductive pads 30a-30d and the ground plane. It is also noted that the conductive layers are here printed with any suitable conductive ink and the dielectric layers may be printed with any suitable dielectric ink.

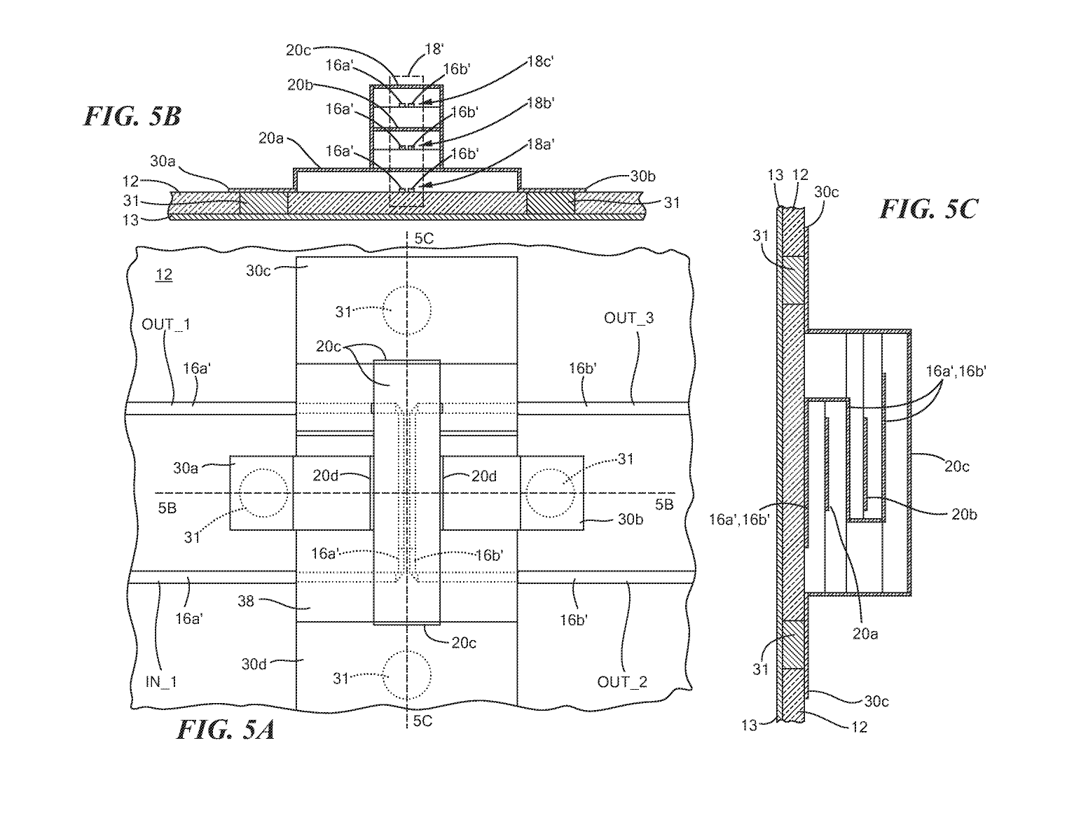

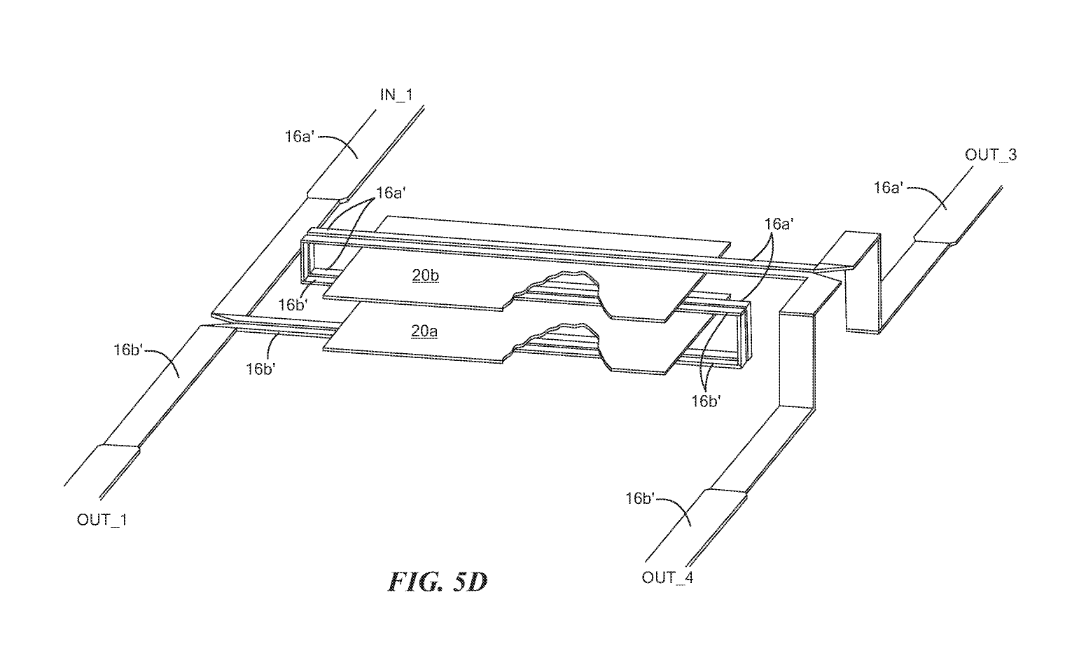

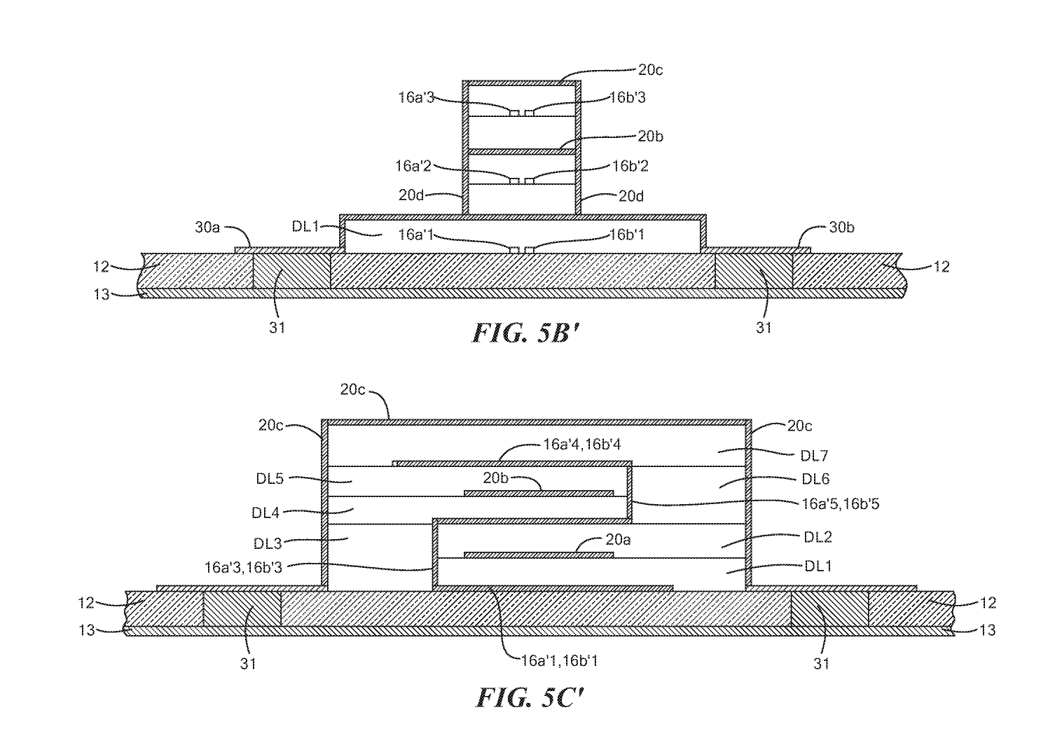

Referring now to FIGS. 5A-5D; here an RF coupler 14′ is shown according to another embodiment of the disclosure formed using the same 3D printing or additive manufacturing techniques described above. Here, the electromagnetic coupling region 18′ includes a plurality, here for example, three electromagnetic coupling sections 18a′-18c′. More particularly, electromagnetic coupling region 18′ comprises a plurality of, here for example three, serially connected, vertically stacked, coupling sections 18a′, 18b′, and 18c′. Here, each one of the coupling sections 18a′, 18b′ and 18c′ includes adjacent portions of the pair of strip conductors 16′a, 16′b, having portions thereof disposed in a side-by-side relationship in a horizontal plane in each of the coupling sections. Again, the portions of the strip conductors 16a, 16b in each pair in the coupling sections 18a′, 18b′ and 18c′ are separated by a dielectric gap, G′, here the gap G′ is disposed in a horizontal, the gap, G′, in the forming an electromagnetic coupling region between the adjacent portions of the pair of strip conductors 16a, 16b.

Further, as described above in connection with the RF coupler 10 (FIG. 2A), the RF coupler 10′ includes two, horizontally disposed, electrically conductive layers 20a, 20b, each one of the electrically conductive layers 20a and 20c being disposed between a corresponding pair of the vertically stacked coupling sections 18a′, 18b′ and 18c′, as shown. More particularly, conductive layer 20a is disposed between coupling sections 18a′ and 18b′ and conductive layer 20b is disposed between coupling sections 18b′ and 18c′. An electrically conductive layer 20c and 20d provides an upper or top cover for the RF coupler 14′, and electrically conductive layer 20d provides sides for the RF coupler 14′; it being noted that the electrically conductive layers 20a-20d are electrically interconnected one to the other and are electrically connected to conductive pads 30a-30d; such conductive pads 30a-30d being electrically connected to the ground plane conductor 13 by electrically conductive vias 31 passing vertically through the substrate 12 n connection with hybrid coupler 10, FIG. 2A to provide the electrostatically conductive shield 22 around the coupling sections 18a′-18c′ as described in FIG. 2A.

Still more particularly, and referring to FIGS. 5B′ and 5C′, the strip conductor 16a′ includes serially connected conductive layers 16a′1 through layer 16a′5 and strip conductor 16b′ layer 16a′ includes serially connected conductive layers 16b′1 through layer 16b′5. Thus, the coupler 10′ is formed by 3D printing or additive manufacture by the following material deposition sequence: Strip conductor layers 16′a1 and 16b′1; dielectric layer DL1; conductive layer 20a; dielectric layer DL2; strip conductors layers 16′a2, 16b′2; strip conductor layers 16a′3, 16b′3 (connecting strip conductors layers 16′a1, 16b′1 to strip conductor layers 16a′2, 16b′2, respectively); dielectric layer DL 3; dielectric layer DL4; conductive layer 20b; dielectric layer DL5; strip conductor layers 16a′4, 16b′4; strip conductor layers 16a′5, 16b′5 (connecting strip conductor layers 16a′4, 16b′4 to strip conductor layers 16a′2, 16b′2, respectively); dielectric layer DL6; dielectric layer DL 7; conductive layer 20c; and conductive layer 20d (connecting conductive layers 20a, 20b and 20c and also connecting such conductive layers 20a, 20b and 20c to the ground plane conductor 13 through the conductive vias 31).

A number of embodiments of the disclosure have been described. Nevertheless, it will be understood that various modifications may be made without departing from the spirit and scope of the disclosure. For example, while three levels of coupling regions 18a-18c have been described, the number of coupling sections may be two or more than three. Further, multi-material printing options using multiple printing heads may be used reducing the number of printing steps. Accordingly, other embodiments are within the scope of the following claims.

1. An RF coupler, comprising:
a plurality of electrically connected, vertically stacked, coupling sections, each one of the coupling sections comprising
a pair of dielectrically separated strip conductors, the strip conductors being separated by an electromagnetic coupling region disposed between the pair of strip conductors;
a plurality of electrically conductive layers, each one of the electrically conductive layers being disposed between a pair of the vertically stacked coupling sections; and
an electric shield disposed over top and sides of the coupling sections.

2. The RF coupler recited in claim 1 including a solid dielectric structure disposed between the plurality of electrically connected, vertically stacked, coupling sections and the electric shield.

3. The RF coupler recited in claim 2 wherein the dielectric structure comprises:
a plurality of dielectric layers, at least one the dielectric layers having a horizontal portion and a vertical portion, the vertical portion being disposed at an end of the horizontal portion;
wherein each one of the plurality of dielectric layers is disposed over at least one electromagnetic coupling region; and
wherein the vertical portion of the at least one of the plurality of dielectric layers having the horizontal portion and a vertical portion being disposed between a corresponding one of the plurality of vertically stacked, coupling sections layers and a corresponding portion of an inside surface of the electric shield.

4. The RF coupler recited in claim 3 wherein the electric shield comprises electrically connected portions of a second plurality of electrically conductive layers.

5. The RF coupler recited in claim 3 wherein the vertical portion of the at least one of the plurality of dielectric layers having the horizontal portion and a vertical portion is a continuous layer.

6, 7 and 8. (canceled)

9. The RF coupler recited in claim 4 including a plurality of connected electrically conductive layers disposed between adjacent pairs of the dielectric layers.

10. An RF coupler, comprising:
a plurality serially connected, vertically stacked, coupling sections, each one of the coupling sections comprising:
a pair of strip conductors separated by an electromagnetic coupling region between the portion of the pair of strip conductors; and
wherein the pair of strip conductors in one of the coupling sections is eclectically connected to the pair of strip conductors in another one of coupling sections;
wherein the pair of strip conductors in one of the coupling sections is disposed in an overlaying, vertical relationship with the pair of strip conductors in another one of coupling sections; and
an electric shield disposed over top and sides of the plurality serially connected, vertically stacked coupling sections.

11. The RF coupler recited in claim 10 including a solid dielectric structure disposed between the plurality serially connected, vertically stacked, coupling sections and the electric shield,

12. The RF coupler recited in claim 11 wherein the solid dielectric structure, comprises:
a plurality of dielectric layers, at least one the dielectric layers having a horizontal portion and a vertical portion, the vertical portion being disposed at an end of the horizontal portion;
wherein each one of the plurality of dielectric layers is disposed over at least one electromagnetic coupling region; and
wherein the vertical portion of the at least one of the plurality of dielectric layers having a horizontal portion and a vertical portion is disposed between a corresponding one of the plurality of vertically stacked, coupling sections layers and a corresponding portion of an inside surface of the electric shield.

13. The RF coupler recited in claim 12 wherein the at least one of the dielectric layers having the horizontal portion and a vertical portion is a single continuous layer.

14. An RF coupler, comprising;
a plurality of electrically connected, vertically stacked, coupling sections, each one of the coupling sections comprising:
a pair of dielectrically separated strip conductors, the strip conductors being separated by an electromagnetic coupling region disposed between the pair of strip conductors;
an electrically conductive layer disposed between the pair of dielectrically separated strip conductors of one of the coupling sections and the pair of dielectrically separated strip conductors of another one of the coupling sections;
a pair of vertically disposed dielectric layers, the electrically conductive layer being disposed between the pair of dielectrically separated strip conductors;
wherein the pair of vertically disposed dielectric layers comprises a dielectric ink; and
wherein an end portion of one of the pair of vertically disposed dielectric layers is disposed on an end portion of one of the pair of dielectrically separated strip conductors of one of the coupling sections.

15. The RF coupler recited in claim 14 including an electric shield disposed over top and sides of the plurality of electrically connected, vertically stacked, coupling sections and wherein the pair of vertically disposed dielectric layers is disposed on the electric shield.

16. The RF coupler recited in claim 14 wherein the pair of dielectrically separated strip conductors comprise a conductive ink.

17. The RF coupler recited in claim 15 wherein the pair of dielectrically separated strip conductors comprise a conductive ink.

18. The RF coupler recited in claim 15 wherein the electric shield comprises a conductive ink.

19. The RF coupler recited in claim 18 wherein the pair of dielectrically separated strip conductors comprise a conductive ink.

20. An RF coupler, comprising:
a plurality of electrically connected, vertically stacked, coupling sections, each one of the coupling sections comprising:
a pair of dielectrically separated strip conductors disposed in an inner region of the electrically connected, vertically stacked, coupling section, the strip conductors being disposed in a horizontal plane and separated by an electromagnetic coupling region disposed between the pair of strip conductors, a first one of the pair of dielectrically separated strip conductors being disposed vertically over a second one of the dielectrically separated strip conductors;
an electrically conductive interconnecting layer disposed on an outer region of the electrically connected, vertically stacked, coupling section and passing vertically between an end of a first one the pair of dielectrically separated strip conductors of the coupling section to an end of a second one of the pair of dielectrically separated strip conductors of another one of the coupling sections electrically interconnecting the pair dielectrically separated strip conductors; and
a dielectric structure, disposed between the pair of dielectrically separated ship conductors, having an end disposed on an inner surface of the electrically conductive interconnecting layer disposed on the outer region of the plurality of electrically connected, vertically stacked, coupling section.
